(19) United States
(12) Patent Application Publication
(10) Pub. No.: US 2026/0260242 A1
(43) Pub. Date: Sep. 3, 2026

(54) COMPUTER SYSTEMS AND METHODS FOR INTELLIGENTLY TUNING THE THRESHOLDS OF A RULE-BASED MODEL

(71) Applicant: Capital One Financial Corporation, McLean, VA (US)

(72) Inventors: Yunsheng Xiao, Chicago, IL (US); Van Vo, Manvel, TX (US); Siddhesh Subhashchandra Jagtap, Chicago, IL (US); Shanmukha Hemanth Reddy Indla, Denton, TX (US)

(21) Appl. No.: 19/068,857

(22) Filed: Mar. 3, 2025

(51) Int. Cl. G06Q 20/40

(52) U.S. Cl. CPC G06Q 20/4016

(57) ABSTRACT

A computing platform is installed with executable software for intelligently adjusting (or “tuning”) the thresholds of certain threshold-based rules included in a rule-based model that is automatically being executed to perform some task, where that executable software causes the computing platform to (i) obtain a set of alerts produced by the rule-based model, (ii) determine, for each respective threshold-based rule in at least a subset of the threshold-based rules, a respective set of one or more candidate values for the respective threshold of the respective threshold-based rule by binning the alerts and evaluating the bins, (iii) generate candidate combinations of values for the respective thresholds based on the determined sets of one or more candidate values, and (iv) identify one or more of the candidate combinations of values to recommend as options for performing an above-the-line adjustment of the respective thresholds.

### BACKGROUND

It is becoming increasingly important for financial institutions to monitor for suspicious activity that may be occurring in connection with financial transactions, such as payment card transactions, transfers, deposits, withdrawals, peer-to-peer (P2P) transactions, electronic check transactions, etc. Such suspicious activity may take various forms, such as fraud (e.g., check fraud, credit card fraud, kiting, loan fraud, etc.), racketeering, embezzlement, money laundering, terrorism financing, identity theft, trafficking (e.g., drug trafficking, human trafficking, etc.), tax evasion (e.g., cash transaction structuring, etc.), bribery, extortion, and insider trading, among other possibilities. The consequences of such suspicious activity may take various forms for financial institutions, such as monetary losses (e.g., lost revenue for financial institutions, lost savings for consumers, etc.), loss of customers, reputational damage, violation of laws or regulations, government fines, and even bankruptcy, among other possibilities. Furthermore, the consequences of such suspicious activity within society may extend well beyond the damage suffered by financial institutions. Individuals may lose their life savings, organized crime syndicates may be empowered to operate with impunity, terrorist organizations may be strengthened, and, in severe cases, the very stability of national financial systems and/or governments may be threatened, among other possibilities.

### OVERVIEW

Disclosed herein is new software technology for intelligently adjusting (or “tuning”) the thresholds of certain threshold-based rules included in a rule-based model that is automatically being executed to perform some task.

In one aspect, the disclosed technology may take the form of a method to be carried out by a computing platform that involves (i) obtaining a set of alerts produced by a rule-based model that is configured to render predictions of a given type based on feature values for an input set of feature variables, wherein the rule-based model comprises threshold-based rules that each include a respective threshold for a respective feature variable from the input set of feature variables, (ii) for each respective threshold-based rule in at least a subset of the threshold-based rules, determining a respective set of one or more candidate values for the respective threshold of the respective threshold-based rule by (a) arranging the set of alerts into a respective group of bins that each contains a different subset of the set of alerts and are each defined by a different feature-value range for the respective feature variable of the respective threshold-based rule, (b) identifying, from among the respective group of bins, a first bin defined by a first feature-value range for the respective feature variable of the respective threshold-based rule that is closest to a current value for the respective threshold of the respective threshold-based rule, (c) comparing a first true-positive rate of a first subset of alerts contained within the first bin to a threshold true-positive rate and thereby make a determination that the first true-positive rate is less than the threshold true-positive rate, (d) identifying, from among the respective group of bins, a second bin defined by a second feature-value range for the respective feature variable of the respective threshold-based rule that is second closest to the current value for the respective threshold of the respective threshold-based rule, (e) comparing a second true-positive rate of a second subset of alerts contained within the second bin to a threshold true-positive rate and thereby make a determination that the second true-positive rate is less than the threshold true-positive rate, (f) based on the determinations that the first and second true-positive rates are both less than the threshold true-positive rate, determining a first candidate value to include in the respective set of one or more candidate values for the respective threshold of the respective threshold-based rule, wherein the first candidate value is more aggressive than the current value for the respective threshold, and (g) carrying out additional functionality for determining whether to include one or more additional candidate values in the respective set of one or more candidate values for the respective threshold of the respective threshold-based rule, (iii) based on the respective sets of one or more candidate values that are determined for the respective thresholds of the respective threshold-based rules in at least the subset of the threshold-based rules, generating candidate combinations of values for the respective thresholds, and (iv) identifying one or more of the candidate combinations of values for the respective thresholds as one or more recommended options for performing an above-the-line adjustment of the respective thresholds, where the rule-based model may thereafter be updated to include a given one of the candidate combination of values for the respective thresholds in place of a current combination of values for the respective thresholds.

The rule-based model may take any of various forms, and in at least some embodiments, the rule-based model may be configured to render predictions of whether transaction activity is suspicious.

Further, the first candidate value that is determined for each respective threshold-based rule in at least the subset of the threshold-based rules may take any of various forms, and in at least some embodiments, the first candidate value that is determined for each respective threshold-based rule in at least the subset of the threshold-based rules may be determined based on the second feature-value range that defines the second bin.

Further yet, the additional functionality for determining whether to include the one or more additional candidate values in the respective set of one or more candidate values for the respective threshold of each respective threshold-based rule in at least the subset of the threshold-based rules may take any of various forms, and in at least some embodiments, such additional functionality may involve (a) identifying, from among a respective updated group of bins, an updated first bin defined by an updated first feature-value range for the respective feature variable of the respective threshold-based rule that is closest to the first candidate value for the respective threshold of the respective threshold-based rule, (b) comparing an updated first true-positive rate of an updated first subset of alerts contained within the updated first bin to the threshold true-positive rate and thereby make a determination that the updated first true-positive rate is less than the threshold true-positive rate, (c) identifying, from among the respective updated group of bins, an updated second bin defined by an updated second feature-value range for the respective feature variable of the respective threshold-based rule that is second closest to the first candidate value for the respective threshold of the respective threshold-based rule, (d) comparing an updated second true-positive rate of an updated second subset of alerts contained within the updated second bin to a threshold true-positive rate and thereby make a determination that the updated second true-positive rate is less than the threshold true-positive rate, and (d) based on the determinations that the updated first and updated second true-positive rates are both less than the threshold true-positive rate, determining a second candidate value to include in the respective set of one or more candidate values for the respective threshold of the respective threshold-based rule, wherein the second candidate value is more aggressive than the first candidate value for the respective threshold. Additionally, in at least some examples of such embodiments, the respective updated group of bins for each respective threshold-based rule in at least the subset of the threshold-based rules may comprise either an updated version of the respective group of bins that excludes the first bin and includes all other bins of the respective group of bins or a respective new group of bins that is generated by (1) updating the set of alerts to remove the first subset of alerts contained within the first bin and (2) arranging the update set of alerts into the respective new group of bins that each contains a different subset of the updated set of alerts and are each defined by a different feature-value range for the respective feature variable of the respective threshold-based rule, among other possible examples.

Still further, the function of identifying the one or more of the candidate combinations of values for the respective thresholds as the one or more recommended options for performing an above-the-line adjustment of the respective thresholds may take any of various forms, and in at least some embodiments, may involve (a) evaluating a respective performance level of each of the candidate combinations of values for the respective thresholds, and (b) based on evaluating the respective performance level of each of the candidate combinations of values for the respective thresholds, identify the one or more of the candidate combinations of values for the respective thresholds as the one or more recommended options for performing an above-the-line adjustment of the respective thresholds. Additionally, in at least some examples of such embodiments, the function of evaluating the respective performance level of each of the candidate combinations of values for the respective thresholds may involve determining, for each of the candidate combinations of values for the respective thresholds, one or both of (i) a respective indication of how many additional false negatives would have occurred during a past window of time if a current combination of values for the respective thresholds had been replaced by the candidate combination of value for the respective thresholds or (ii) a respective indication of a true-positive rate that would have been achieved during the past window of time if the current combination of values for the respective thresholds had been replaced by the candidate combination of value for the respective thresholds, among other possible examples.

In another aspect, disclosed herein is a computing platform that includes a communication interface for communicating over at least one data network, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In yet another aspect, disclosed herein is a non-transitory computer-readable medium provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 an example network environment in which aspects of the disclosed software technology disclosed herein can be implemented.

FIG. 2 depicts a block diagram of an example software-based pipeline that carries out functionality disclosed herein.

FIG. 3A depicts tables that show illustrative examples of groups of bins that could be produced by the example software-based pipeline.

FIG. 3B depicts some example recommendation options that may be output by the example software-based pipeline for performing an “above-the-line” adjustment of the example rule-based model's thresholds.

FIG. 4A illustrates one possible example of functionality that may be carried out by a threshold-analysis component of the example software-based pipeline.

FIG. 4B illustrates one possible example of additional functionality that may be carried out by a threshold-analysis component of the example software-based pipeline.

FIG. 5 is a flow chart of example of functionality that may be carried out in accordance with the software technology disclosed herein.

FIG. 6 depicts a simplified block diagram to illustrate some structural components that may be included in an example computing platform that may be configured to perform some or all of the platform functions disclosed herein.

FIG. 7 depicts a simplified block diagram to illustrate some structural components that may be included in an example client device that may be configured to perform some or all of the client-device functions disclosed herein.

### DETAILED DESCRIPTION

As noted above, it is becoming increasingly important for financial institutions to monitor for suspicious activity that may be occurring in connection with financial transactions, such as payment card transactions, transfers, deposits, withdrawals, peer-to-peer (P2P) transactions, electronic check transactions, etc. Such suspicious activity may take various forms, such as fraud (e.g., check fraud, credit card fraud, kiting, loan fraud, etc.), racketeering, embezzlement, money laundering, terrorism financing, identity theft, trafficking (e.g., drug trafficking, human trafficking, etc.), tax evasion (e.g., cash transaction structuring, etc.), bribery, extortion, and insider trading, among other possibilities. The consequences of such suspicious activity may take various forms for financial institutions, such as monetary losses (e.g., lost revenue for financial institutions, lost savings for consumers, etc.), loss of customers, reputational damage, violation of laws or regulations, government fines, and even bankruptcy, among other possibilities. Furthermore, the consequences of such suspicious activity within society may extend well beyond the damage suffered by financial institutions. Individuals may lose their life savings, organized crime syndicates may be empowered to operate with impunity, terrorist organizations may be strengthened, and, in severe cases, the very stability of national financial systems and/or governments may be threatened, among other possibilities.

Given the significance of these consequences, it is important for financial institutions to monitor transactions involving the financial accounts they maintain in order to identify transaction activity that appears to be suspicious and then take action to avoid or remedy such suspicious transaction activity. However, given the large volume of transactions that are now processed each day, it is not practically possible for financial institutions to have their employees review transactions for potentially suspicious activity. As such, technology has been developed to help financial institutions identify transaction activity that is likely to be suspicious in nature. For instance, software technology has been developed that functions to (i) monitor transactions in real time for potential suspicious activity by evaluating information about the transactions and the account holders involved in the transactions (i.e., the financial institution's customers) and (ii) generate alerts for suspicious transaction activity, which could be based on a single transaction or a set of multiple transactions (e.g., multiple transactions involving a same account holder). This technology is often referred to as “transaction monitoring” software, and one representative example of such transaction monitoring software is the Suspicious Activity Monitoring (SAM) software offered by NICE Actimize, although various other examples of transaction monitoring software exist as well.

Transaction monitoring software may use rule-based models to determine whether to flag transaction activity as suspicious. Such a rule-based model may generally comprise a combination of individual rules that can each evaluate to either true or false, where such rules are connected together with logical “OR” and/or “AND” operators in order to output an overall outcome of either (i) true, which indicates that the transaction activity being evaluated appears to be suspicious and should be flagged, or (ii) false, which indicates that the transaction activity being evaluated does not appear to be suspicious and should not be flagged. For example, in a rule-based model, the rules could be connected together (i) entirely with “OR” operators, in which case the rule-based model outputs a true outcome if any one of the individual rules evaluates to true, (ii) entirely with “AND” operators, in which case the rule-based model outputs a true outcome if all of the individual rules evaluate to true, or (iii) with a mix of “OR” and “AND” operators, such as a rule-based model comprising a combination of rule “segments” connected by “OR” operators where each such segment could comprise either a single rule or a set of multiple rules connected by “AND” operators, in which case in which case the rule-based model outputs a true outcome if any one of the individual rule segments evaluate to true.

In such a rule-based model, at least a subset of the individual rules may take the form of threshold-based rules, each of which comprises a respective threshold that is applied to a feature value for a respective feature variable that is numeric in nature. For instance, the respective threshold of a threshold-based rule may be (i) a minimum threshold (or sometimes referred to as a “lower-bound threshold”) for a respective feature variable, in which case the rule evaluates to true (e.g., indicates suspicious transaction activity) when a feature value for the respective feature variable less than or perhaps equal to the minimum threshold, or (ii) a maximum threshold (or sometimes referred to as an “upper-bound threshold”) the respective feature variable, in which case the rule evaluates to true (e.g., indicates suspicious transaction activity) when a feature value for the respective feature variable is greater than or perhaps equal to the respective threshold. Additionally, in some cases, a threshold-based rule for a given feature variable may comprise multiple thresholds that collectively define which ranges of values of the given feature variable will cause the rule to evaluate to true versus which ranges of values of the given feature variable will cause the rule to evaluate to false. One example of such a multi-threshold threshold may take the form of a rule specifying that if the given feature variable's value falls inside of a range defined by a first bound and a second bound, the rule evaluates to true, which may conceptually be thought of as an “AND” combination of (i) a first threshold rule having a maximum threshold that is the lower of the first and second bounds and (ii) a second threshold rule having a minimum threshold that is the higher of the first and second bounds. Conversely, another example of such a multi-threshold threshold may take the form of a rule specifying that if the given feature variable's value falls outside of a range defined by a first threshold and a second threshold, the rule evaluates to true, which may conceptually be thought of as an “AND” combination of (i) a first threshold rule having a minimum threshold that is the lower of the first and second bounds and (ii) a second threshold rule having a maximum threshold that is the higher of the first and second bounds. A threshold-based rule may take other forms as well.

Further, in practice, a rule-based model could also include other types of individual rules, such as rules for evaluating feature variables that are categorical in nature (e.g., rules that perform equality checks, membership checks, range checks, or the like).

Rule-based models such as these may also be utilized to render various other types of predictions as well.

While rule-based models tend to impose a lower computational burden on computing systems than more complicated types of models (e.g., machine-learning models such as neural networks) and tend to be more explainable, there are still various problems that can arise when rule-based models are used in automated systems for performing tasks such as detecting suspicious transaction activity. For instance, the accuracy of rule-based models that apply threshold-based rules depends on the thresholds that are used. When a rule-based model's thresholds are too conservative, the rule-based model may generate a larger extent of alerts, and while many of the generated alerts will be true positives (i.e., correct predictions of true), there will also be some extent of the generated alerts that are false positives (i.e., incorrect predictions of true). To illustrate with an example, if a threshold-based rule for a given feature variable evaluates to true when the given feature variable's value is less than a minimum threshold, then having that minimum threshold set too high may result in the threshold-based rule evaluating to true for a larger range of values of the given feature variable than is desirable or necessary. Or as another example, if a threshold-based rule for a given feature variable evaluates to true when the given feature variable's value is great than a maximum threshold, then having that maximum threshold set too lower may result in the threshold-based rule evaluating to true for a larger range of values of the given feature variable than is desirable or necessary. In this respect, the overly conservative thresholds may increase the recall of the rule-based model (e.g., the number of true positives that are flagged by the rule-based model), but may also reduce the precision of the rule-based model (e.g., the extent of generated alerts that are actually true positives). This reduction in precision can give rise to various problems. For example, when a rule-based model generates alerts for suspicious transaction activity, whether correctly or not, the use of additional resources (e.g., more complicated models that are less computationally efficient and/or investigator review processes) may be triggered to evaluate whether or not the transaction activity is actually suspicious. As a result, transaction activity that is incorrectly flagged as being suspicious (e.g., false positives) may lead to a waste of valuable resources.

On the other hand, when a rule-based model's thresholds are too aggressive (e.g., when minimum thresholds are too low and/or maximum thresholds too high), the rule-based model may generate a smaller extent of alerts, and while this may reduce the extent of the generated alerts that are false positives, it may also increase the extent of false negatives (i.e., incorrect predictions of false). In this respect, the overly aggressive thresholds may increase the precision of the rule-based model, but they may also reduce the recall of the rule-based model. This reduction in recall can also give rise to various problems. For example, when a rule-based model fails to generate an alert for transaction activity that is suspicious, the rule-based model has, in essence, failed to perform its intended function. As a result, the transaction activity that is suspicious and not flagged as such may go undetected, thereby allowing bad actors to exploit vulnerabilities in automated systems for detecting suspicious transaction activity.

In practice, rule-based models that are used to perform complex tasks such as detecting suspicious transaction activity often include tens, hundreds, or perhaps even thousands of threshold-based rules that are combined together in order to render predictions, which is due in large part to the fact that the performance of rule-based models (e.g., prediction accuracy) tends to increase as the number of feature variables and corresponding rules included in the rule-based models increase. As a result, it is not practically possible for a human to determine the combination of thresholds for a rule-based model that will best optimize the balance between avoiding false positives and avoiding false negatives, or in other words, the balance between precision and recall. Rather, the task of determining the combination of thresholds for a rule-based model requires a technological, data-driven solution.

One existing approach for determining the thresholds of a rule-based model is called above-the-line (ATL)/below-the-line (BTL) testing. In this approach, the thresholds used by the rule-based model are set to some initial level and those thresholds are then iteratively adjusted until the rule-based model reaches an acceptable level of performance. For instance, during a given iteration of an ATL/BTL testing process, one or more of the thresholds used by the rule-based model is updated to be more aggressive (e.g., by decreasing a minimum threshold and/or increasing a maximum threshold) or more conservative (e.g., by increasing a minimum threshold and/or decreasing a maximum threshold). After the one or more thresholds have been updated, the rule-based model is used to generate alerts (e.g., when transaction activity is flagged as being suspicious) for a period of time. The performance of the rule-based model is then evaluated (e.g., by determining a true-positive rate) to determine whether the one or more updated thresholds result in better model performance than the prior thresholds. (In practice, it takes many iterations of adjusting thresholds to discover a combination of thresholds that yields acceptable performance levels.). However, this approach has several drawbacks.

First, as noted above, the dimensionality of rule-based models that are used that are used to perform complex tasks such as detecting suspicious transaction activity tends to be large so that these rule-based models can achieve levels of performance that are considered acceptable. This large dimensionality complicates the process of adjusting the thresholds because an adjustment to a threshold for one rule may have a downstream effect on other rules, making it difficult to determine which thresholds to change and which thresholds to leave unchanged during any given iteration.

Second, ATL/BTL testing it is currently a trial-and-error approach in which there is not a systematic, well-defined way to determine how much to adjust each threshold. The magnitude of the adjustments made to the thresholds in each iteration of ATL/BTL testing generally has to be relatively small to ensure convergence to an optimal combination of thresholds (e.g., because using overly large adjustments may cause this approach to repeatedly overshoot such an optimal combination of thresholds). However, the smaller the adjustments made to the thresholds at each iteration are, the more iterations it may take to converge to an optimal combination of thresholds (e.g., as measured by metrics such as true-positive rate, precision, recall, etc.) because a vast space of possible combinations of thresholds may have to be explored through trial and error. Each iteration, in turn, may take a non-trivial amount of time to complete because each alert generated by the rule-based model may have to be reviewed to determine whether it is a true positive or a false positive so that the performance of the rule-based model after each iteration can be evaluated. As a result, in practice, it may take months or years to complete a sufficient number of iterations to discover an optimal combination of thresholds. In the interim, the rule-based model may continue to generate false positives and/or fail to recognize false negatives, thereby giving rise to the problems explained above.

Third, along with lacking a systematic, well-defined way to determine how much (or how often) to adjust each threshold, the current approaches also lack a systematic, well-defined way to evaluate performance or make decisions regarding which thresholds to select.

Fourth, in some circumstances, an optimal combination of thresholds may be a moving target that this approach moves too slowly to hit. For instance, once a rule-based model has been deployed, bad actors who are involved in suspicious activities may go about reverse-engineering the rules that the rule-based model applies and evolve their behavior to prevent suspicious activities from being detected. As the behavior of bad actors changes, the optimal combination thresholds may change along with it—and this approach may move too slowly to keep up.

To address these and other problems with existing technology for adjusting the thresholds of a rule-based model, disclosed herein is software technology that employs a data-driven approach for intelligently adjusting (or “tuning”) the thresholds of certain threshold-based rules included in a rule-based model that is automatically being executed by a computing platform to perform some task. For purposes of illustration, the disclosed software technology is at times described below in the context of adjusting the thresholds for threshold-based rules connected by logical “AND” operators, because these combinations of rules present more complex interactions than threshold-based rules connected by logical “OR” operators, but it should be understood that the disclosed software technology may be utilized to adjust thresholds for any combination of two or more threshold-based rules included in a rule-based model. Further, for purposes of illustration, the disclosed software technology is at times described below in the context of a rule-based model for detecting suspicious transaction activity, but it should be understood that the disclosed technology may be utilized to adjust the thresholds of rule-based models for rendering other types of predictions as well.

The disclosed software technology may be embodied in the form of a software-based pipeline that carried out functionality for determining whether and to what extent to adjust a rule-based model's thresholds based on an evaluation of a set of alerts that were previously generated by the rule-based model. Such a software-based pipeline may begin by obtaining a set of alerts that were generated by the rule-based model. In turn, software-based pipeline may utilize the obtained set of alerts to carry out a sequence of functionality on a threshold-by-threshold basis for each of at least a subset of the thresholds included in the rule-based model in order to determine whether and to what extent the threshold can be adjusted to a more aggressive level, which may result in either a determination that the threshold cannot be adjusted to a more aggressive level or a determination of a set of one or more “candidate” values for the threshold that may be evaluated as a possible replacement for the threshold's current value. This functionality for determining whether and to what extent a threshold can be adjusted to a more aggressive level-which may be referred to herein as the disclosed “threshold-tuning functionality” may take any of various forms.

In at least one implementation, the disclosed “threshold-tuning functionality” for a given threshold of the rule-based model may begin with the software-based pipeline carrying out a univariate binning process on the set of alerts with respect to the given feature variable of the rule-based model that is evaluated by the given threshold and thereby generating a group of bins that each contains a respective subset of the set of alerts, where each respective bin in the group is defined by different feature-value range for the given feature variable. In turn, the software-based pipeline may carry out functionality for analyzing the group of bins in order to determine whether and to what extent to modify the given threshold.

The functionality for analyzing the group of bins in order to determine whether and to what extent to modify the given threshold may take various forms, and in at least some implementations, may involve: (i) identifying, from among the group of bins, a first bin defined by the feature-value range that is closest to the current value for the given threshold, (ii) determining a first true-positive rate of the alerts contained within the first bin, and (iii) based on a comparison of the first true-positive rate to a threshold true-positive rate, either (a) determine that the given threshold should not be adjusted to a more aggressive level (and perhaps initiating a separate process for determining whether to adjust the threshold to a more conservative level) if the first true-positive rate exceeds the threshold true-positive rate or (b) carry out additional functionality for determining whether the given threshold can be adjusted to a more aggressive level (which is typically referred to as an “above-the-line” adjustment) if the first true-positive rate does not exceed a threshold true-positive rate.

In turn, the additional functionality for determining whether the given threshold can be adjusted to a more aggressive level may involve (i) identifying, from among the group of bins, a second bin having associated feature-value ranges that are second closest to the current combination of values for the rule-based model's thresholds (which will also typically be the bin that is closest to first bin's associated feature-value ranges), (ii) determining a second true-positive rate of the alerts contained within the second bin, and (iii) based on a comparison of the second true-positive rate to the threshold true-positive rate, either (a) determine that the given threshold should not be adjusted to a more aggressive level if the second true-positive rate exceeds the threshold true-positive rate or (b) determine that the given threshold could potentially be adjusted to a first candidate value that is above-the-line relative to the given threshold's current value (e.g., the value that is at the “floor” of the second bin's feature-value range) if the second true-positive rate does not exceed the threshold true-positive rate.

If the software-based pipeline reaches the point of determining the given threshold could potentially be adjusted to the first candidate value, the software-based pipeline may then carry out one or more subsequent iterations of functionality that is similar to the foregoing functionality in order determine whether the given threshold could potentially be adjusted to one or more additional candidate values that are above-the-line relative to the first candidate value. In this respect, each subsequent iteration may involve updating the set of alerts to remove the alerts that are below-the-line relative to the last-determined candidate value for the given threshold (e.g., the first candidate value for the second iteration) and then either (i) carrying out another iteration of the univariate binning process on the updated set of alerts, which results in an updated group of bins comprising updated first and second bins that are identified and evaluated in the manner explained above for the current iteration, or (ii) reusing the same group of bins from the prior iteration but redesignating the second and third bins from the prior iteration as updated first and second bins that are identified and evaluated in the manner explained above for the current iteration. During each subsequent iteration, the software-based pipeline may either (i) determine that no additional candidate value can be determined for the given threshold, such as if the updated first or second bins do not have a true-positive rate that exceeds the threshold true-positive rate, which may also serve as a stopping condition for evaluating additional candidate values for the given threshold, or (ii) determine an additional candidate value for the given threshold that is more aggressive than the prior candidate value determined for the given threshold.

The foregoing threshold-tuning functionality may thus result in a determination of either no candidate values for the given threshold (if even the first bin if the first iteration exceeds has a true-positive rate that exceeds the threshold true-positive rate) or a determination of a set of one or more candidate values for the given threshold.

In line with the discussion above, the software-based pipeline may carry out this threshold-tuning functionality on a threshold-by-threshold basis (e.g., in a sequential or parallel manner) for each of multiple different thresholds to be evaluated, which may result in the determination of a respective set of one or more candidate values (or perhaps no candidate value) for each of the multiple different thresholds. Thereafter, the software-based pipeline may (i) generate multiple different candidate combinations of values for the thresholds using on the current and candidate values for the thresholds, (ii) evaluate the performance of each of the candidate combinations of values for the thresholds (e.g., based on a performance metric such as a number of false negatives, a true-positive rate, etc.), and (iii) based on the evaluation, identify and output one or more of the candidate combinations of candidate values for the thresholds as one or more recommended options for performing an “above-the-line” adjustment of the rule-based model's thresholds. For example, if the software-based pipeline determines a respective set of two candidate values (in addition to the current value) for each of three thresholds of the rule-based model, the software-based pipeline may function to (i) generate up to twenty-six possible candidate combinations of values for the three thresholds (where the current value of each such threshold could be included as part of the combinations such that each threshold has three possible values and there are a total of twenty-seven possible combinations but that is inclusive of the combination of current values for the three thresholds), (ii) evaluate the performance of each of the twenty-six candidate combinations of values for the thresholds, and (iii) based on the evaluation, identify and output one or more of the twenty-six candidate combinations of values for the thresholds as one or more recommended options for performing an “above-the-line” adjustment of the rule-based model's thresholds.

After the software-based pipeline outputs the one or more recommended options for performing an “above-the-line” adjustment of the rule-based model's thresholds, a given one of the combinations of candidate values for the thresholds may be adopted the rule-based model may then be updated to include the adopted combination of candidate values in place of the current values for the thresholds.

The functionality of the disclosed software-based pipeline may take various other forms as well, and is described in greater detail below.

Advantageously, the disclosed software technology for adjusting a rule-based model's thresholds provides a number of technological improvements over the existing technology for determining and/or adjusting a rule-based model's thresholds. For instance, compared to existing ATL/BTL approaches, the disclosed software technology increases efficiency by facilitating convergence to an improved thresholds after fewer iterations. This increased efficiency allows better model performance to be achieved in a shorter amount of time. In particular, when implemented in rule-based models, the improved combinations of thresholds that are determined by the disclosed technology may result in both greater precision and greater recall—fewer of the alerts generated by such rule-based models are false positives, yet there are also fewer false negatives. Further, the reduced number of iterations involved in converging to the improved combinations of thresholds may result in a reduced amount of time between updates to rule-based models, thereby allowing such rule-based models to evolve more quickly in response to changes in the behavior of bad actors engaging in suspicious transactions activity. Further yet, the disclosed technology is capable of automatically and intelligently determining and adjusting the thresholds of a rule-based model comprising a very large number of individual threshold-based rules and thus has a combination of threshold with a very large dimensionality, such as a rule-based model comprising hundreds or perhaps even thousands of individual threshold-based rules and associated thresholds.

The disclosed software technology also provides other advantages over the existing technology, which are apparent from the detailed discussion of the software technology that follows.

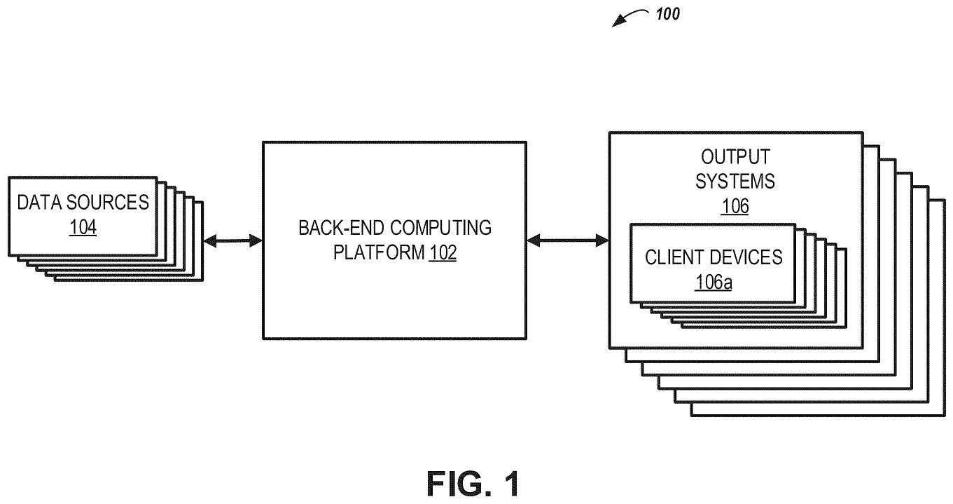

Turning now to the figures, FIG. 1 depicts one illustrative example of a computing environment 100 in which the disclosed software technology may be implemented. As shown, the example computing environment 100 may include a back-end computing platform 102 operated on behalf of an entity that is interested in monitoring financial transactions for suspicious activity (e.g., a financial institution that maintains financial accounts for account holders), a plurality of data sources 104, and a plurality of output systems 106, among other possibilities.

The back-end computing platform 102 may comprise any one or more computer systems (e.g., one or more servers) that have been installed with software for carrying out the back-end functionality disclosed herein. In practice, the one or more computer systems of the back-end computing platform 102 may collectively comprise some set of physical computing resources (e.g., one or more processors, data storage systems, communication interfaces, etc.), which may take any of various forms. As one possibility, the back-end computing platform 102 may comprise cloud computing resources supplied by a third-party provider of “on demand” cloud computing resources, such as Amazon Web Services (AWS), Amazon Lambda, Google Cloud, Microsoft Azure, or the like. As another possibility, the back-end computing platform 102 may comprise “on-premises” computing resources of the given provider (e.g., servers owned by the given provider). As yet another possibility, the back-end computing platform 102 may comprise a combination of cloud computing resources and on-premises computing resources. Other implementations of the back-end computing platform 102 are possible as well.

Further, in practice, the software for carrying out the back-end functionality disclosed herein may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the software for carrying out the back-end functionality disclosed herein may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities. Such a data storage layer of the back-end computing platform 102 may contain any of various types of data, including, but not limited to, any of the various types of data involved in carrying out the back-end functionality disclosed here.

As shown, the back-end computing platform 102 may be communicatively coupled to a plurality of data sources 104 over respective communication paths. In general, each of these data sources 104 may comprise a computing system that is configured to provide the back-end computing platform 102 with data related to the back-end functionality disclosed herein, such as transaction data, merchant data, timing data, shipping data, account-holder data, and/or aggregated data (each of which is described in greater detail below), among other possible types of data that may be provided by the data sources 104.

As further shown, the back-end computing platform 102 may be communicatively coupled to a plurality of output systems 106 over respective communication paths. The output systems 106—and the output data and/or instructions that the back-end computing platform 102 provides to the output systems 106—may take various forms. To illustrate, FIG. 1 shows client devices 106a as representative examples of the output systems 106 that may receive output data and/or instructions from back-end computing platform 102. However, it should be understood that the client devices 106a are merely provided for purposes of illustration and that the back-end computing platform 102 may be configured to send output data and/or instructions to other types of output systems as well.

In general, each of these client devices 106a may comprise any computing device that enables a user to access and interact with the back-end computer platform 102 in order to carry out tasks related to the disclosed back-end functionality, such as configuration of the back-end functionality and/or evaluation of output provided by back-end computing platform 102. In this respect, each client device 106a may include hardware components such as one or more processors, computer-readable mediums, communication interfaces, and input/output (I/O) components (or interfaces for connecting thereto), among other possible hardware components, as well as software that enables a user to access and interact with the back-end computing platform 102 in order to carry out tasks related to the disclosed back-end functionality (e.g., operating system software, web browser software, a mobile application, etc.). As representative examples, each of example client devices 106a may take the form of a desktop computer, a laptop, a netbook, a tablet, a smartphone, or a personal digital assistant (PDA), among other possibilities.

In practice, the respective communication path between the back-end computing platform 102 and each data source 104 or output system 106 may generally comprise one or more data networks and/or data links, which may take any of various forms. For instance, the respective communication path between the back-end computing platform 102 and a given data source 104 or output system 106 may include any one or more of a Personal Area Network (PAN), a Local Area Network (LAN), a Wide Area Networks (WAN) such as the Internet or a cellular network, a cloud network, and/or a point-to-point data link, among other possibilities, where each such data network and/or link may be wireless, wired, or some combination thereof, and may carry data according to any of various different communication protocols. Additionally, the communication between the back-end computing platform 102 and a given data source 104 or output system 106 could be carried out via an Application Programming Interface (API), among other possibilities. Additionally, although not shown, the respective communication path between the back-end computing platform 102 and a given data source 104 or output system 106 could also include one or more intermediate systems, examples of which may include a data aggregation system or a host server, among other possibilities. Many other configurations are also possible.

It should be understood that the computing environment 100 is one example of a computing environment in which the disclosed software technology may be implemented, and that numerous other examples of computing environments are possible as well. For instance, in some implementations, the back-end computing platform 102 may additionally have a communication path with a third-party computing platform that is provided with access to data generated by the back-end computing platform 102 in accordance with the disclosed back-end functionality via an API or the like.

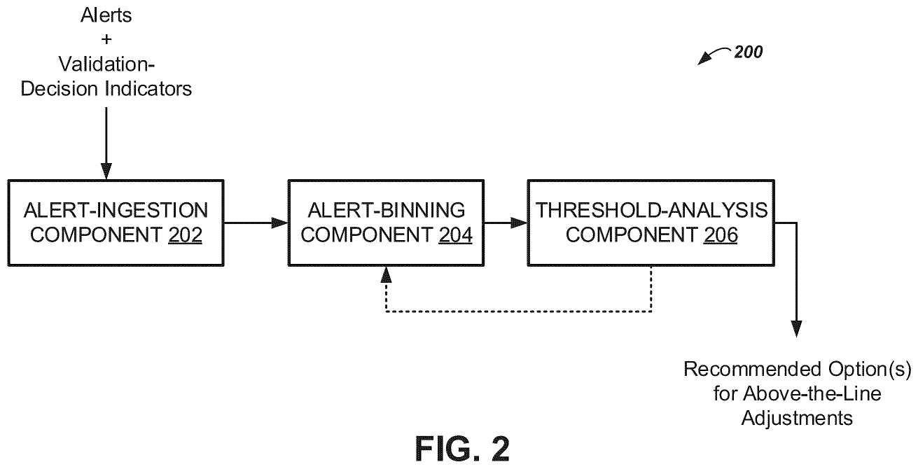

Turning now to FIG. 2, a block diagram is of an example software-based pipeline 200 that carries out functionality for determining whether and to what extent to adjust a rule-based model's thresholds is shown. In practice, the example software-based pipeline 200 may comprise a set of functional components, each of which may be encoded in the form of program instructions that are executable by one or more processors of one or more computing platforms. For purposes of illustration, the example software-based pipeline 200 is described as being installed on and executed by the back-end computing platform 102 of FIG. 1, but it should be understood that the example software-based pipeline 200 may be installed on and executed by any one or more computing platforms that are capable of performing the example operations of the example software-based pipeline 200, and in some cases, different components of the example software-based pipeline 200 may be executed by different computing platforms that communicate with one another via network-based communication paths. Further, it should be understood that the example software-based pipeline 200 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular embodiment.

In accordance with the present disclosure, the rule-based model that is evaluated by the example software-based pipeline 200 may take the form of any rule-based model comprising a combination of threshold-based rules that are connected by logical “OR” and/or “AND” operators. (In line with the discussion above, the rule-based model could also optionally include other types of rules in addition to the threshold-based rules, but such other types of rules will generally not be adjusted in accordance with the disclosed technology). In this respect, the rule-based model may determine whether any individual threshold-based rule is satisfied (i.e., evaluates to true) by comparing the rule's respective threshold (or a pair of thresholds) to a feature value for the rule's respective feature variable (e.g., to determine whether a condition that the threshold-based rule specifies is met).

For instance, if a threshold-based rule includes a minimum threshold for a given feature variable, then the rule-based model may determine that the threshold-based rule has been satisfied (i.e., evaluates to true) if a feature value for the given feature variable is less than or perhaps equal to the minimum threshold. For example, if the symbol v is used to represent a feature value for a given feature variable and the symbol t is used to represent a minimum threshold for the given feature variable, the inequality “ν≤t” would represent a threshold-based rule that is satisfied if the feature value is less than or equal to the minimum threshold (i.e., t is an “inclusive” minimum threshold) and the inequality “ν<t” would represent a threshold-based rule that is satisfied if the feature value is less than the minimum threshold but not satisfied if the feature value equals the minimum threshold (i.e., t is an “exclusive” minimum threshold).

As another possibility, if a threshold-based rule includes a maximum threshold for a given feature variable, then the rule-based model may determine that the threshold-based rule has been satisfied (i.e., evaluates to true) if a feature value for the given feature variable is greater than or perhaps equal to the maximum threshold. For example, if the symbol v is used to represent a feature value for a given feature variable and the symbol t is used to represent a maximum threshold for the given feature variable, the inequality “ν≥t” would represent a threshold-based rule that is satisfied if the feature value is greater than or equal to the maximum threshold (i.e., t is an “inclusive” maximum threshold) and the inequality “ν>t” would represent a threshold-based rule that is satisfied if the feature value is greater than the maximum threshold but not satisfied if the feature value equals the maximum threshold (i.e., t is an “exclusive” maximum threshold).

A threshold-based rule and the corresponding functionality for evaluating whether a threshold-based rule is satisfied may also take other forms.

Further, the inputs and outputs of the rule-based model that is evaluated by the example software-based pipeline 200 may take any of various forms, although in general, (i) the input of the rule-based model may comprise an input record containing feature values for some set of feature variables that are related to the type of prediction being rendered by the rule-based model and (ii) the output of the rule-based model may comprise a positive or negative prediction.

Further yet, the positive predictions that are output by the rule-based model that is evaluated by the example software-based pipeline 200 may be memorialized in the form of “alerts” that each comprises a data record containing data related to a respective positive prediction that is output by the rule-based model (e.g., the feature values that led to the rule-based model outputting the positive prediction).

In line with the discussion above, one example type of such a rule-based model may take the form of a rule-based model for detecting suspicious transaction activity, which may function to (i) receive feature values for a given set of feature variables that are indicative of whether or not given transaction activity is suspicious, (ii) based on applying the rule-based model's combination of rules (including any applicable threshold-based rules) to the feature values, predict whether the given transaction activity is suspicious, and (iii) if the given transaction activity is predicted to be suspicious (i.e., if the prediction is positive), generate and output an alert for the given transaction activity. In this respect, the given transaction activity could involve a given transaction or a set of multiple given transactions (e.g., multiple transactions made by a same account holder), and the given set of feature variables that are indicative of whether or not the given transaction activity is suspicious may take any of various forms.

For instance, as one possibility, the given set of feature variables that are indicative of whether or not the given transaction activity is suspicious may include feature variables that provide data related to an individual transaction involved in the given transaction activity, which may be referred to herein as “transaction data variables.” Such individual-transaction data variables may take any of various forms.

As one illustrative example, the transaction data variables for an individual transaction involved in the given transaction activity may include monetary data variables (e.g., measured in units given currency), such as an indication of an amount paid, an indication of an amount deposited, and/or an indication of an amount withdrawn in the given transaction, among other possible types of monetary data variables.

As another illustrative example, the transaction data variables for an individual transaction involved in the given transaction activity may include goods/services data variables, such as an indication of a quantity of a products and/or service purchased via the given transaction, among other possible types of goods/services data variables.

As yet another illustrative example, the transaction data variables for an individual transaction involved in the given transaction activity may include merchant data variables, such as a merchant risk score associated with a merchant involved in the given transaction, among other possible types of merchant data variables

As yet another illustrative example, the transaction data variables for an individual transaction involved in the given transaction activity may include timing data variables, such as an indication of a time at which the given transaction was initiated (e.g., a timestamp indicating an hour of the day and/or a date), an indication of a time of day at which the given transaction was completed (e.g., a timestamp indicating an hour of the day and/or a date), an indication of an amount of time taken to complete the given transaction, and/or an indication of an time taken for the given transaction to clear, among other possible examples of timing data variables.

As yet another example, the transaction data variables for an individual transaction involved in the given transaction activity may include shipping data variables, such as an indication of a shipping cost, among other possible examples of shipping data variables.

The transaction data variables for an individual transaction involved in the given transaction activity may also take other forms.

As another possibility, the given set of feature variables that are indicative of whether or not the given transaction activity is suspicious may include feature variables related to an account holder (e.g., an entity such as a person or a business that holds a financial account) involved in the given transaction activity, which may be referred to herein as “account-holder data variables.” Such account-holder data variables may take any of various forms.

As one illustrative example, the account-holder data variables for an account holder involved in the given transaction activity may include transaction-activity data variables that indicate transaction activity by the account holder during a recent window of time (e.g., the past one or more days, past one or more weeks, past one or more months, etc.), such as a data variable that indicates an aggregated amount of transactions made by the account holder during a recent window of time (e.g., an aggregated amount withdrawn, deposited, and/or a paid during the recent window of time) and/or a number of transactions made by the account holder during a recent window of time (a number of withdrawals, deposits, and/or payments), among other possible types of transaction-activity data variables.

As another illustrative example, the account-holder data variables for an account holder involved in the given transaction activity may include account-description data variables, such as a balance (e.g., a ledger balance, an available balance, a credit balance, etc.) and/or an indication of one or more account restrictions (e.g., a credit limit, a daily Automated Teller Machine (ATM) withdrawal limit, a daily debit purchase limit, a transaction limit, a daily Peer-to-Peer (P2P) payment limit, etc.), among other possible types of account-description data variables.

As yet another illustrative example, the account-holder data variables for an account holder involved in the given transaction activity may include demographic data variables associated with the account holder (e.g., if the account holder is a person) that is legally permitted to be used to detect suspicious transaction activity, such as an age of the account holder and/or an income amount (e.g., a gross annual income) associated with the account holder to the extent legally permitted, among other possible types of demographic data variables.

As yet another illustrative example, the account-holder data variables for an account holder involved in the given transaction activity may include business-description data variables (e.g., if the account holder is a business), such as balance-sheet data variables (e.g., gross profit, net profit, etc.) for the account holder, among other possible types of business-description data variables for the account holder.

As yet another illustrative example, the account-holder data variables for an account holder involved in the given transaction activity may include creditworthiness data variables about the account holder, such as a credit score (e.g., a Fair Isaac Corporation (FICO®) score, a VantageScore®, an insurance score, etc.), a debt-to-income (DTI) ratio, a credit utilization ratio, and/or a length of credit history, among other possible types of creditworthiness data variables.

As yet another illustrative example, the account-holder data variables for an account holder involved in the given transaction activity may include an indicator of whether there is any adverse-media data regarding the account holder, such as a news website, a news broadcast, a blog, an online review, a social media posting, and/or some other type of medium, among other possible types of adverse-media data.

As yet another illustrative example, the account-holder data an account holder involved in the given transaction activity may include an indicator of whether the account holder is a politically exposed person (PEP).

The account-holder data variables for an account holder involved in the given transaction activity may also take other forms.

As yet another possibility, the given set of feature variables that are indicative of whether or not the given transaction activity is suspicious may include data variables that provide data about other parties that are involved in the given transaction activity, such as data about a merchant involved in the given transaction activity. Such merchant data variables could be similar in nature to the types of account-holder data variables described above, and one representative example of such a merchant data variable may take the form of a transaction-activity data variable that indicates an aggregated amount of transactions involving the merchant (or perhaps multiple merchants) during a recent window of time, although other types of merchant data variables are possible as well (e.g., risk-based factors such as MCC, JRR, and/or CRS).

Other types of features variables that are indicative of whether or not a given transaction activity is suspicious may be evaluated as well, including but not limited to other feature variables that are categorical rather than numeric in nature (e.g., a data variable that indicates a jurisdiction in which a party to the given transaction resides or is incorporated or a jurisdiction where the given transaction takes place) and may be evaluated by the rule-based model using other types of rules that are suited for evaluating categorical data variables.

As discussed above, based on the evaluation of transaction activity, the rule-based model may identify transaction activity that appears to be suspicious and then generate alerts for such suspicious transaction activity. These alerts may take any of various forms. For instance, as one possibility, an alert that is generated for given transaction activity may comprise an identification of the given transaction activity, at least a subset of the feature values for the given transaction activity that were provided as input into the rule-based model, and perhaps also other data that may subsequently be utilized by investigators or the like to determine whether or not the given transaction activity is in fact suspicious such that it should be reported to the appropriate authorities, among other possible types of data that may be included or otherwise associated with an alert generated by a rule-based model for detecting suspicious activity. The alerts that are generated may also take other forms.

In accordance with the present disclosure, the alerts that are generated by the rule-based model may then be stored in a manner that enables the alerts to be accessed by the example software-based pipeline 200 (e.g., by storing the alerts in the data storage layer of the back-end computing platform 102).

Further, in accordance with the present disclosure, the alerts that are generated by the rule-based model may also undergo a subsequent validation process during which an investigator or the like evaluates whether the alerts are true positives or false positives and then inputs a respective validation decision for each respective alert that indicates whether the respective alert is determined to be a true positive or a false positive, which is then memorialized in the form of an validation-decision indicator (e.g., a value of 1 for a true-positive decision or 0 for a false-positive decision) that is stored in conjunction with the respective alert (e.g., as part of the respective alert itself or as a separate data entity that is linked to the respective alert). In a scenario where the alerts are for suspicious transaction activity, the validation decisions may also govern whether the alerts are reported to a government agency (e.g., the Financial Crimes Enforcement Network (FinCEN) in the United States or Serious Organised Crime Agency (SOCA) in the United Kingdom) in the form of a suspicious activity report (SAR) or the like.

As shown in FIG. 2, the alerts generated by the rule-based model and the corresponding validation-decision indicators for such alerts may then serve as input to the example software-based pipeline 200, which may comprise (i) an alert-ingestion component 202, (ii) an alert-binning component 204, and (iii) a threshold-analysis component 206, among other possible components. Each of these software components will now be described in further detail.

The alert-ingestion component 202 generally functions to ingest a set of alerts generated by the rule-based model (which as noted above generally comprise data records representing the positive predictions output by the rule-based model) along with corresponding validation-decision indicators for such alerts (which as noted above generally comprise indicators of whether the positive predictions are determined to be true or false). For instance, the alert-ingestion component 202 may load the alerts and/or the corresponding validation-decision indicators from a data storage layer (e.g., a data storage layer of the back-end computing platform 102) and/or from another location where the alerts and the corresponding validation-decision indicators are stored, among other possible ways that the alert-ingestion component 202 may ingest the set of alerts and corresponding validation-decision indicators.

In practice, the set of alerts that are ingested by the alert-ingestion component 202 may comprise alerts that were generated by the rule-based model during some window of time in the past, such a lookback window that spans months or even years in the past.

After the set of alerts and corresponding validation-decision indicators have been ingested, the alert-ingestion component 202 may (i) provide the set of alerts to the alert-binning component 204 and (ii) provide the set of alerts and corresponding validation-decision indicators (or perhaps just the validation-decision indicators if they are maintained separately) to the threshold-analysis component 206, among other possible component that may be provided with the alerts and/or the validation-decision indicators.

The functionality of the alert-ingestion component 202 may take other forms as well.

The alert-binning component 204 begins the portion of the software-based pipeline 200 that carries out functionality on threshold-by-threshold basis for each threshold of the rule-based model that is to be evaluated for adjustment (e.g., thresholds for threshold-based rules that are connected by “AND” operators), and for each such threshold, the alert-binning component 204 generally functions to carry out a univariate binning process on the set of alerts with respect to the feature variable that is governed by the threshold and thereby generate a group of bins that are each defined by a respective feature-value range for the feature variable and each contains a respective subset of the ingested set of alerts having associated feature values for the feature variable that fall within the bin's respective feature-value range. For instance, a first bin that is generated by the alert-binning component 204 for a given threshold that governs a given feature variable may be defined by a first feature-value range for the given feature variable governed by the given threshold, a second feature-value range for the given feature variable, and so on. In this respect, each bin's respective feature-value range may comprise either a pair of two bound values for the given feature variable, such as a lower-bound feature value and an upper-bound feature value for the given feature variable, or may comprise a single bound value for the given feature variable, such as a lower-bound feature value only (in which case the upper bound of the feature-value range is undefined) or an upper-bound feature value only (in which case the lower bound of the feature-value range is undefined), among other possible ways that a feature-value range may be defined.

Further, in practice, the different feature-value ranges that may be defined for the given feature variable during the univariate binning process will typically comprise discrete intervals of the overall universe of feature values for the given feature variable. For example, if the given threshold comprises a maximum threshold that must be satisfied in order for an alert to be generated, then the universe of feature values for the given feature variable will generally have a lowest overall value that is greater than or perhaps equal to the current value of that maximum threshold (because all generated alerts will be associated with a feature value for the given feature variable that is greater than or perhaps equal to the current value of that maximum threshold), and the bottommost feature-value range for the given feature variable will comprise a lower bound that is the lowest overall value for the given feature variable and an upper bound that is some other value that is higher than the lowest overall value but lower than the highest overall value for the given feature variable. In turn, there may be one or more other feature-value ranges for the given feature variable that are above the bottommost feature-value range (i.e., have a lower bound that is greater than the upper bound of the bottommost feature-value range), with the topmost feature-value range for the given feature variable encompassing the highest overall value for the given feature variable. In this example, all of the feature-value ranges are considered “above-the-line” ranges because they all encompass values that satisfy the maximum threshold, and the bottommost feature-value range would be considered the feature-value range that is “closest to the line” because it is the feature-value range that sits closest to the current value of the maximum threshold. Further, in this example, the upper bound of each respective feature-value range would be considered the “ceiling” of the respective feature-value range because it is the bound that is further away from the maximum threshold, and the lower bound of each feature-value range would be considered the “floor” of the respective feature-value range because it is the bound that is closer to the maximum threshold.

On the other hand, if the given threshold comprises a minimum threshold that must be satisfied in order for an alert to be generated, then the universe of feature values for the given feature variable will generally have a highest overall value that is less than or equal to the current value of that minimum threshold (because all generated alerts will be associated with a feature value for the given feature variable that is less than or equal to the current value of that minimum threshold), and the topmost feature-value range for the given feature variable will comprise an upper bound that is the highest overall value for the given feature variable and a lower bound that is some other value that is lower than the highest overall value but higher than the lowest overall value for the given feature variable. In turn, there may be one or more other feature-value ranges for the given feature variable that are below the topmost feature-value range (i.e., have an upper bound that is less than the lower bound of the topmost feature-value range), with the bottommost feature-value range for the given feature variable encompassing the lowest overall value for the given feature variable. In this example, all of the feature-value ranges are considered “above-the-line” ranges because they all encompass values that satisfy the minimum threshold (even despite the fact that the values are mathematically “below” the minimum threshold), and the topmost feature-value range would be considered the feature-value range that is “closest to the line” because it is the feature-value range that sits closest to the current value of the minimum threshold. Further, in this example, the lower bound of each respective feature-value range would be considered the “ceiling” of the respective feature-value range because it is the bound that is further away from the minimum threshold, and the upper bound of each feature-value range would be considered the “floor” of the respective feature-value range because it is the bound that is closer to the minimum threshold.

The foregoing functionality may be illustrated in the context of an example rule-based model for determining whether transaction activity involving a given account holder and one or more merchants is suspicious, where the rule-based model includes among its combination of rules: (i) a first threshold-based rule that includes a maximum threshold of $2800 for a first feature variable indicating an aggregated amount of transactions made by the account holder during a given window of time (e.g., the past one or more days, one or more weeks, etc.), which may be referred to herein as the “TRAN_AGG” variable, (ii) a second threshold-based rule that includes a maximum threshold of 7 for a second feature variable indicating a number of transactions made by the account holder during the given window of time (e.g., the past one or more days, one or more weeks, etc.), which may be referred to herein as the “TRAN_OCC” variable, and (iii) a third threshold-based rule that includes an maximum threshold of $2900 for a third feature variable indicating an aggregated amount of transactions made by the one or more merchants during the given window of time (e.g., the past one or more days, one or more weeks, etc.), which may be referred to herein as the “MCC_AGG” variable.

For each of these three feature variables, the alert-binning component 204 may carry out a separate univariate binning process on the set of alerts in order to generate a respective group of bins that are defined with respect to the values of the feature variable. Or more specifically, the alert-binning component 204 may generate a first group of bins that are defined with respect to the values of the TRAN_AGG variable, a second group of bins that are defined with respect to the values of the TRAN_OCC variable, and a third group of bins that are defined with respect to the values of the MCC_AGG variable.

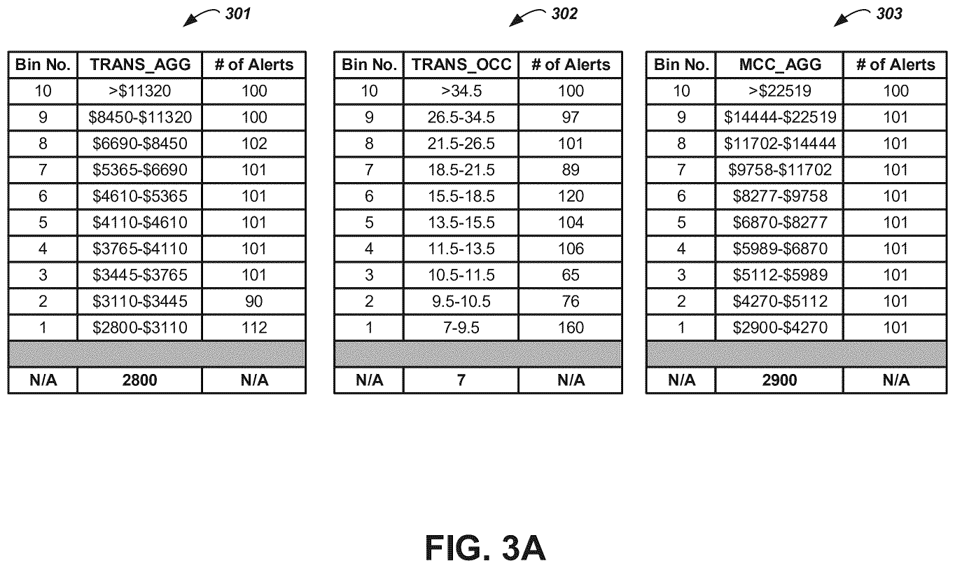

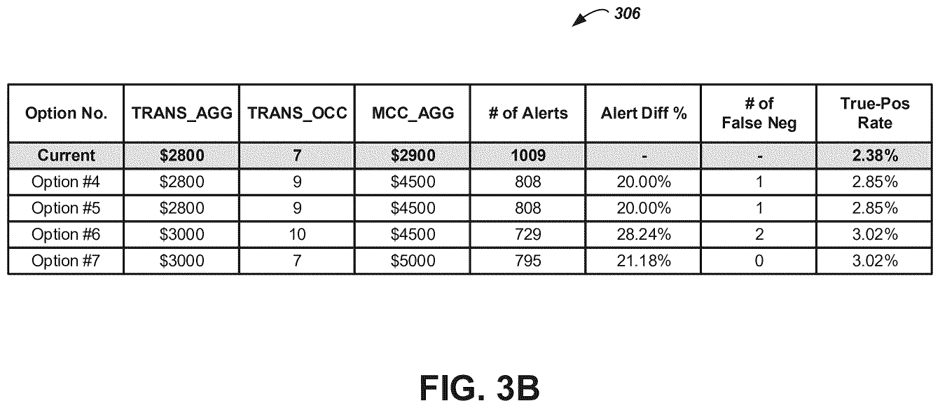

To illustrate, FIG. 3A shows examples of variable-specific groups of bins that may be produced by the alert binning component for a set of alerts produced by the example rule-based model introduced above. In particular, a first table 301 shows a first example group of bins that has been produced for the TRAN_AGG variable, a second table 302 shows a second example group of bins that has been produced for the TRAN_OCC variable, and a third table 303 shows a third example group of bins that has been produced for the MCC_AGG variable.

Each of tables 301, 302, and 303 is shown to include a first column labeled as “Bin No.” that includes bin-specific identifiers for the applicable feature variable, a second column labeled with an identified of the applicable feature variable (i.e., “TRANS_AGG,” “TRANS_OCC,” or “MCC_AGG”) that includes bin-specific ranges of values for the applicable feature variable, and a third column labeled as “#of Alerts” that indicates a total number of alerts in each of the bins. Additionally, each of the tables 301, 302, and 303 is shown to include a bottom row that indicates the current value of the threshold for the applicable feature variable.

In the example shown in FIG. 3A, the bins are defined by feature-value ranges that are all “above-the-line” relative to the current threshold values shown in the bottom rows of tables 301, 302, and 303—where a feature-value range is considered to be “above-the-line” relative to a maximum threshold if it encompasses values that are greater than (or perhaps equal) to the current value of the maximum threshold and is considered to be “above-the-line” relative to a minimum threshold if it encompasses values that are less than or equal to the current value of the minimum threshold. More particularly, the feature-value ranges that are shown for the three feature variables in FIG. 3A are all considered to be “above-the-line” because the threshold-based rules for all three feature variables include maximum thresholds and the feature-value ranges encompass values that are all greater than (or perhaps equal) to the current values of such maximum thresholds. On the other hand, if a threshold-based rule for some other feature variable (e.g., a feature variable indicating a credit score) includes a minimum threshold, the “above-the-line” feature-value ranges would encompass values that are all less than (or perhaps equal) to the current value of the minimum threshold.

Further, in the example shown in FIG. 3A, the bins are ordered within the tables 301, 302, 303 based on how “close to the line” the bins are to the current threshold value for the applicable feature variable. For instance, in table 301, bin number 1 is defined by a feature-value range that is closest to the current threshold value shown in the bottom row of the table 301, bin number 2 is defined by a feature-value range that is second-closest to the current threshold value shown in the bottom row of the table 301, and so on for each of the other bins, with bin number 10 being the bin defined by a feature-value range that is furthest from the current threshold value shown in the bottom row of the table 301. (In this example, the feature-value range that is closest to the current threshold value for each applicable feature variable is shown to be inclusive of the current threshold value, which may be the case in a scenario where a threshold-based rule is satisfied by a value that is equal to the threshold. In other scenarios, the feature-value range that is closest to the current threshold value for a given feature variable may not be inclusive of the current threshold value, but rather may be a feature-value range having a floor value that is either greater than the current threshold value for a maximum threshold or less than the current threshold value for a minimum threshold).

It will be understood that the example bins and corresponding feature-value ranges shown in FIG. 3A are merely provided for purposes of illustration, and that the group of bins generated by the alert-binning component 204 may take various other forms as well, including but not limited to the possibility that the alert-binning component 204 may generate (i) a different number of bins, (ii) bins having various different sizes and/or distributions of feature-value ranges, (iii) bins that are defined with respect to a different number of feature variables (e.g., tens, hundreds, or even thousands of feature variables), and/or (iv) bins that are defined with respect to feature variables of various other forms, among various other possibilities.

Further, the univariate binning process that is carried out by the alert-binning component 204 in order to generate a group of bins with respect to a given feature variable of the rule-based model may take any of various forms, and in at least some implementations, may involve utilizing a given set of one or more binning parameters and a given type of binning technique and to bin the alerts, each of which may take any of various forms.

For instance, the given set of one or more binning parameters that is utilized to bin the alerts may include a constraint related to a number of bins to be generated (e.g., a minimum or maximum number of bins), a constraint related to a number of alerts that can be included in each bin (e.g., a minimum or maximum number of alerts that can be included in each bin and/or a minimum or maximum percentage of total alerts that can be included in each bin), and/or constraints related to the feature-value ranges that define the different bins (e.g., constraints on how wide the feature-value ranges can be and/or how the feature-value ranges are permitted to change from bin-to-bin), among other possible binning parameters that may be included in the given set of one or more binning parameters. Further, in practice, the given set of one or more binning parameters may be defined in any of various ways, including but not limited to the possibility that each such binning parameter could be defined based on user input that is received from an individual involved in the process of setting the thresholds for the rule-based model (e.g., via a client device) prior to execution of the software-based pipeline 200 or could be hard-coded into the software-based pipeline 200, among other possibilities.

Turning next to the type of univariate binning process that is utilized to bin the alerts with respect to a given feature variable, as one possibility, the univariate binning process may take the form of an a frequency-based binning process that divides up the alerts generated by the rule-based model (based on the values of the given feature variable) into bins that satisfy a constraint related to the number of alerts included in the bins. The constraint related to the number of alerts included in the bins may take various forms, examples of which may include a number of alerts that meets a target number of alerts, a number of alerts that falls between a minimum and maximum number of alerts, or a number of alerts that is no more than a threshold difference from the number of alerts in any other bin, among other possible examples of the constraint related to the number of alerts included in the bins.

In such a frequency-based binning technique, the given set of one or more binning parameters may include at least the constraint related to the number of alerts included in the bins, and perhaps also other binning parameters such as a constraint on a number of bins to generate.

As another possibility, the type of univariate binning process that is utilized to bin the alerts with respect to a given feature variable may take the form of a “cluster-based” binning technique that divides up the alerts produced by the rule-based model (based on the values of the given feature variable) into bins that each contains a respective cluster of the alerts as determined by a clustering technique such as centroid-based clustering (e.g., K-means clustering), hierarchical clustering, density-based clustering, or distribution-based clustering.

In such a cluster-based binning technique, the given set of one or more binning parameters may include parameters for the clustering technique utilized to cluster the alerts and perhaps also other binning parameters such as a constraint related to the number of alerts to be included in the bins and/or a constraint on a number of bins to generate.

The type of univariate binning process that is utilized to bin the alerts with respect to a given feature variable may take other forms as well, including but not limited to types of univariate binning processes that divide up the alerts produced by the rule-based model into bins that satisfy constraints related to the feature-value ranges that define the different bins-such as constraints on how wide the different feature-value ranges for the given feature variables can be and/or how the feature-value ranges are permitted to change from bin-to-bin.

In line with the discussion above, the alert-binning component 204 may carry out the foregoing functionality on threshold-by-threshold basis for each threshold of the rule-based model that is to be evaluated for adjustment (e.g., thresholds for threshold-based rules that are connected by “AND” operators). In this respect, the alert-binning component 204 may be configured to carry out the univariate binning process for the thresholds to be evaluated either in parallel or in series, among other possibilities. Further, in an implementation where the alert-binning component 204 is configured to carry out the univariate binning process for the thresholds in series, the alert-binning component 204 may be configured to either (i) carry out the univariate binning process for each of the thresholds to be evaluated “up front” prior to the threshold-analysis component 206 beginning analysis for any of the thresholds or (ii) carry out the univariate binning process in an iterative manner whereby the alert-binning component 204 waits until the threshold-analysis component's analysis for one threshold has been completed before carrying out the univariate binning process for the next threshold, among other possible implementations.

After generating a group of bins with respect to a given feature variable, the alert-binning component 204 may output certain bin information for the group of bins, which may include any of the following information for each respective bin in the group: (i) an identifier of the respective bin, (ii) an indication of the particular feature-value range that defines the respective bin, and (iii) a number of alerts contained within the respective bin, among other possibilities.

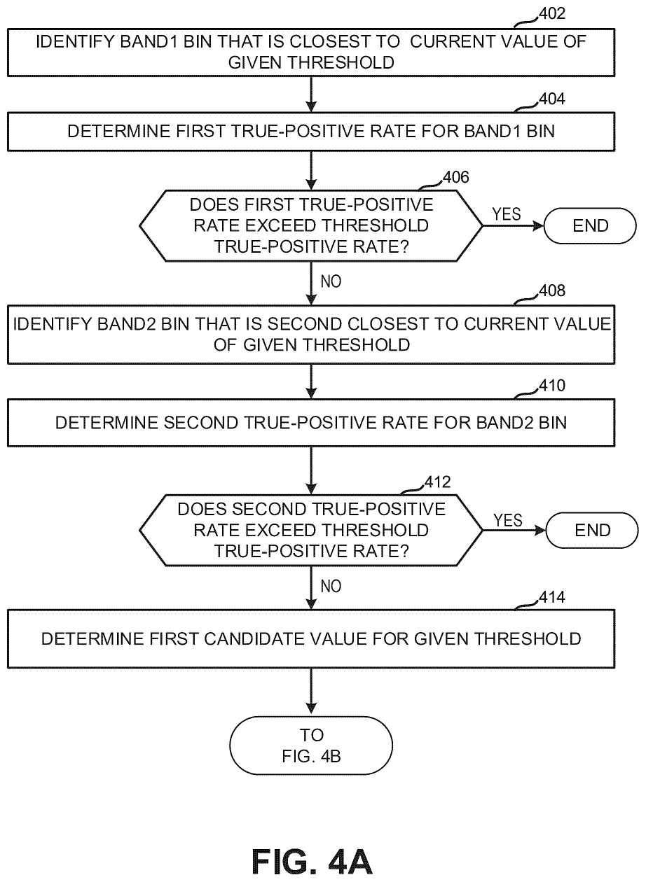

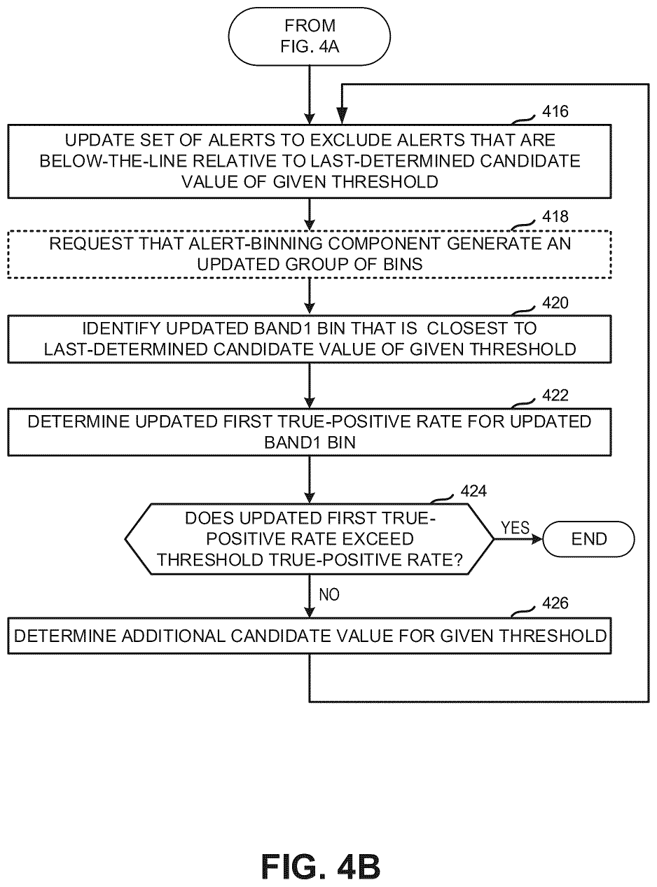

Returning to FIG. 2, the threshold-analysis component 206 continues the portion of the software-based pipeline 200 that carries out functionality on threshold-by-threshold basis for each threshold of the rule-based model that is to be evaluated for adjustment (e.g., thresholds for threshold-based rules that are connected by “AND” operators), and for each such threshold, the threshold-analysis component 206 functions to analyze the group of bins generated by the alert-binning component 204 with respect to the feature variable governed by the threshold in order to determine whether and to what extent to modify the value of the threshold. The functionality of the threshold-analysis component 206 may take various forms, and one possible example of the functionality carried out by the threshold-analysis component 206 for a given threshold that governs a given feature variable is illustrated in FIG. 4A.

As shown in FIG. 4A, the threshold-analysis component may begin at block 402 by identifying, from among the group of bins generated by the alert-binning component 204 with respect to the given feature variable, a first bin defined by a feature-value range for the given feature variable that is closest to the current value for the given threshold, which may be referred to herein as the “Band1” bin. In practice, the bin that is identified as the Band1 bin will typically be the bin having a floor value that is closest to the current value of the given threshold (e.g., the bin having a lower-bound value that is closest to the current value if the given threshold is a maximum threshold or the bin having an upper-bound value that is closest to the current value if the given threshold is a minimum threshold).

To illustrate with respect to the example groups of bins shown in FIG. 3A, the function of identifying the Band1 bin for the example thresholds and corresponding feature variables would involve identifying bin number 1 as the Band1 bin for each, because that is the example bin defined by the “above-the-line” feature-value range that is closest to the current threshold value shown in the bottom row of tables 301, 302, or 303. In particular, the first bin's feature-variable range of $2800-$3110 for the first feature variable, the first bin's feature-variable range of 7-9.5 for the second feature variable, and the first bin's feature-variable range of $2900-$4270 for the third feature variable are each closest to the current threshold value for the feature variable, which comprises a threshold of $2800 for the first feature variable, a threshold of 7 for the second feature variable, and a threshold of $2900 for the third feature variable.

As noted above, it will be understood that the example bins and corresponding feature-value ranges shown in FIG. 3A are merely provided for purposes of illustration, and the bin that is identified by the threshold-analysis component 206 as the Band1 bin may take various other forms as well, including but not limited to the possibility that Band1 bin identified by the threshold-analysis component 206 for a feature variable may be defined by a feature-value range that are not inclusive of the current threshold value for the feature variable.

While the function of identifying the Band1 bin for the given feature variable is described above as being carried out by the threshold-analysis component 206 after the group of bins has been generated by the alert-binning component 204 with respect to the given feature variable, in other implementations, the alert-binning component 204 could identify the Band1 bin as part of the binning functionality described above, in which case the alert-binning component 204 may output an indication of which bin is closest to the current threshold value (e.g., by using a bin identifier of “1” to demarcate the closest bin) and the threshold-analysis component 206 may in turn rely on the alert-binning component's identification of the Band1 bin.

Returning to FIG. 4A, at block 404, the threshold-analysis component 206 may determine a first true-positive rate (sometimes referred to as a “yield rate”) for the Band1 bin identified at block 402. This function of determining the first true-positive rate for the Band1 bin may take any of various forms.

For instance, as one possibility, the threshold-analysis component 206 may determine the first true-positive rate for the Band1 bin by (i) determining a total number of alerts contained in the Band1 bin (e.g., based on the bin information that is output by the alert-binning component 204), (ii) determining a number of alerts contained in the Band1 bin that were found to be true positives (e.g., based on the validation-decision indicators for the set of alerts that are ingested by the alert-ingestion component 202), and (iii) dividing the number of Band1 alerts found to be true positives by the total number of Band1 alerts (and optionally multiplying the result by 100 to represent in the form of a percentage) in order to produce the first true-positive rate for the Band1 bin.

The function of determining the first true-positive rate for the Band1 bin may take other forms as well.

At block 406, the threshold-analysis component 206 may next compare the first true-positive rate for the Band1 bin to a threshold true-positive rate in order to determine whether the first true-positive rate for the Band1 bin exceeds the threshold true-positive rate. (While this determination is described in terms of whether the first true-positive rate for the Band1 bin exceeds the threshold true-positive rate, in other implementations, the threshold-analysis component 206 may determine whether the first true-positive rate for the Band1 bin is at least equal to the threshold true-positive rate). This threshold true-positive rate that is utilized by the threshold-analysis component 206 at block 406 may have any of various values, including but not limited to a value within a range of 1% to 3% (e.g., a value of any of 1%, 1.1%, 1.2%, and so on) if the rule-based model that for detecting suspicious transaction activity (although other ranges with lower minimum values or higher maximum values are also possible). Further, the threshold true-positive rate that is utilized by the threshold-analysis component 206 at block 406 may be determined in any of various manners.

As one possibility, the threshold true-positive rate may be determined based on an analysis of historical alerts that have been generated by the rule-based model, such as an analysis of a distribution of true-positive rates for alerts generated over a period time in the past. For instance, for each time interval in a sequence of time intervals (e.g., each month within a 12-month period), the threshold-analysis component 206 (and/or some other component) may (i) identify alerts produced by the alert-based model during the time interval and (ii) determine a respective true-positive rate for the time interval (e.g., by dividing the number of true-positive alerts generated during the time interval by the total number of alerts generated during the time interval). Next, the threshold-analysis component may compute an average (e.g., mean and/or median) of the respective true-positive rates across the time intervals in the sequence (e.g., by determining a sum of the respective true positive rates and dividing by the sum by the number of time intervals in the sequence) as well as a standard deviation of the respective true-positive rates across the time intervals in the sequence (e.g., by determining a respective difference squared between each respective true-positive rate and the average, determining a sum of the respective distances squared, determining a quotient by dividing the sum by the number of time intervals in the sequence, and determining a square root of the quotient).

After the computed average and the computed standard deviation have been determined, the threshold-analysis component may identify a lower bound of a confidence interval by (i) determining a coefficient value for the standard deviation that represents a given percentile (e.g., 5%) of the true-positive rate based on a standardized normal distribution assumption (e.g., N(μ, σ) with μ as sample average and σ as sample standard deviation), and then (ii) determine the threshold true-positive rate to be the difference between (a) the computed average of the true-positive rates across the time intervals in the sequence and (b) the product of the coefficient value and the computed standard deviation of the true-positive rates across the time intervals in the sequence.

The threshold true-positive rate that is utilized by the threshold-analysis component 206 at block 406 may also be determined in various other manners, including but not limited to the possibility that threshold true-positive rate could be set to a fixed value (e.g., a value specified by a subject matter expert) rather than a value that is determined based on an analysis of historical alerts.

If the threshold-analysis component 206 determines at block 406 that the first true-positive rate for the Band1 bin does exceed the threshold true-positive rate, then this indicates that the given threshold is already sufficiently aggressive and should not be adjusted to a more aggressive level (and in fact should perhaps even be adjusted to a more conservative level), and the functionality of the threshold-analysis component 206 (and the software-based pipeline 200 more generally) will terminate without determining any candidate values for adjusting the given threshold to a more aggressive level. Additionally, in some implementations, a determination at block 406 that the first true-positive rate for the Band1 bin does exceed the threshold true-positive rate may also serve as a basis for initiating a separate process for determining whether to adjust the given threshold to a more conservative level, which may generally involve a “below-the-line” evaluation of input records that did not previously result in the generation of alerts by the rule-based model.

On the other hand, if the threshold-analysis component 206 determines at block 406 that the first true-positive rate for the Band1 bin does not exceed the threshold true-positive rate, then this indicates that the given threshold is potentially too conservative, so the threshold-analysis component 206 may proceed to carry out additional functionality for determining whether the given threshold can be adjusted to a more aggressive level. This additional functionality may take various forms.

For instance, as shown in FIG. 4A, the additional functionality may begin at block 408 with the threshold-analysis component identifying, from among the group of bins generated by the alert-binning component 204 with respect to the given feature variable, a second bin defined by the feature-value range that is second closest to the current value of the given threshold, which may be referred to as the “Band2 bin.” In practice, the bin that is identified as the Band2 bin will be the bin having a floor value that is second closest to the current value of the given threshold (e.g., the bin having a lower-bound value that is second closest to the current value if the given threshold is a maximum threshold or the bin having an upper-bound value that is second closest to the current value if the given threshold is a minimum threshold).

To illustrate with respect to the example groups of bins shown in FIG. 3A, the function of identifying the Band2 bin for the example thresholds and corresponding feature variables would involve identifying bin number 2 as the Band2 bin for each, because that is the example bin defined by the “above-the-line” feature-value range that is second closest to the current threshold value shown in the bottom row of tables 301, 302, or 303. In particular, the second bin's feature-variable range of $3110-$3445 for the first feature variable, the second bin's feature-variable range of 9.5-10.5 for the second feature variable, and the second bin's feature-variable range of $4270-$5112 for the third feature variable are each second closest (after bin number 1) to the current threshold value for the feature variable, which comprises a threshold of $2800 for the first feature variable, a threshold of 7 for the second feature variable, and a threshold of $2900 for the third feature variable.

As noted above, it will be understood that the example bins and corresponding feature-value ranges shown in FIG. 3A are merely provided for purposes of illustration, and the bin that is identified by the threshold-analysis component 206 as the Band2 bin may take various other forms as well, including but not limited to the possibility that Band2 bin identified by the threshold-analysis component 206 may be defined by a feature-value range that is not contiguous with the feature-values range of the Band1 bin (i.e., there could be a gap between Band1 and Band2 feature-value ranges for a feature variable).

While function of identifying the Band2 bin for the given feature variable is described above as being carried out by the threshold-analysis component 206 after the group of bins has been generated by the alert-binning component 204 with respect to the given feature variable, in other implementations, the alert-binning component 204 could identify the Band2 bin as part of the binning functionality described above, in which case the alert-binning component 204 may output an indication of which bin is second closest to the current threshold value (e.g., by using a bin identifier of “2” to demarcate the second closest bin) and the threshold-analysis component 206 may in turn rely on the alert-binning component's identification of the Band2 bin.

Returning to FIG. 4A, at block 410, the threshold-analysis component 206 may determine a second true-positive rate (sometimes referred to as a “yield rate”) for the Band2 bin identified at block 408. This function of determining the second true-positive rate for the Band2 bin may take any of various forms.

For instance, as one possibility, the threshold-analysis component 206 may determine the second true-positive rate for the Band2 bin by (i) determining a total number of alerts contained in the Band2 bin (e.g., based on the bin information that is output by the alert-binning component 204), (ii) determining a number of alerts contained in the Band2 bin that were found to be true positives (e.g., based on the validation-decision indicators for the alerts that are ingested by the alert-ingestion component 202), and (iii) dividing the number of Band2 alerts found to be true positives by the total number of Band2 alerts (and optionally multiplying the result by 100 to represent in the form of a percentage) in order to produce the second true-positive rate for the Band2 bind.

At block 412, the threshold-analysis component may compare the second true-positive rate for the Band2 bin to the threshold true-positive rate in order to determine whether the second true-positive rate for the Band2 bin exceeds the threshold true-positive rate, which as noted above may have any of various values and may be determined in any of various manners. (While this determination is described in terms of whether the second true-positive rate for the Band2 bin exceeds the threshold true-positive rate, in other implementations, the threshold-analysis component 206 may determine whether the second true-positive rate for the Band2 bin is at least equal to the threshold true-positive rate).

If the threshold-analysis component 206 determines at block 412 that the second true-positive rate for the Band2 bin does exceed the threshold true-positive rate, then this indicates that the given threshold should not be adjusted to a more aggressive level that is based on the Band2 bin (because that will result in an unacceptable extent of true-positive alerts falling “below-the-line”), so the functionality of the threshold-analysis component 206 will terminate without determining any candidate values for adjusting the given threshold to a more aggressive level. However, whereas a determination at block 406 that the first true-positive rate for the Band1 bin exceeds the threshold true-positive rate may serve as a basis for initiating a separate process for determining whether to adjust the given threshold to a more conservative level, a determination at block 412 that the second true-positive rate for the Band2 bin exceeds the threshold true-positive rate will typically not serve as a basis for initiating a separate process for determining whether to adjust the given threshold to a more conservative level. Rather, a determination at block 412 that the second true-positive rate for the Band2 bin exceeds the threshold true-positive rate will typically serve as a basis for a decision to keep the given threshold at its current value for the time being.

On the other hand, if the threshold-analysis component 206 determines at block 412 that the second true-positive rate for the Band2 bin also does not exceed the threshold true-positive rate, then this further indicates that the given threshold may potentially be too conservative and can potentially be adjusted to a more aggressive level, so the threshold-analysis component 206 may proceed to block 414, which may involve determining a first candidate value for the given threshold that is “above-the-line” relative to (i.e., more aggressive than) the current value of the given threshold. (In an alternative implementation, instead of the determination of the first candidate value for the given threshold being conditioned on the determination at block 412 that the second true-positive rate for the Band2 bin does not exceed the threshold true-positive rate, it is possible that the determination of the first candidate value for the given threshold could be conditioned on the determination at block 406 that the first true-positive rate for the Band1 bin does not exceed the threshold true-positive rate, in which case the functionality of blocks 408-412 may be skipped).

The function of determining the first candidate value for the given threshold may take any of various forms, and in at least some implementations, may be based on the feature-value range of the Band2 bin. For instance, as one possibility, the threshold-analysis component 206 may determine the first candidate value for the given threshold to be the floor value of the Band2 bin's feature-value range for the given feature variable-which as noted above is whichever bound of the feature-value range is closest to the current value of the given threshold. In practice, such a floor value will either be (i) the lower bound of the feature-value range for the given feature variable if the given threshold is a maximum threshold or (ii) the upper bound of the feature-value range for the given feature variable if the given threshold is a minimum threshold.

To illustrate with respect to the example groups of bins shown in FIG. 3A, this functionality would result in a first candidate value of (i) $3110 for the TRANS_AGG variable, which is the floor value of the Band2 bin's feature-value range for the TRANS_AGG variable, (ii) 9.5 for the TRANS_OCC variable, which is the floor value of the Band2 bin's feature-value range for the TRANS_OCC variable, and (iii) a threshold of $4270 for the MCC_AGG variable, which is the floor value of the Band2 bin's feature-value range for the MCC_AGG variable. However, as noted above, it will be understood that the example bins and corresponding feature-value ranges shown in FIG. 3A are merely provided for purposes of illustration, and the first candidate values that are determined to be the floor values of the Band2 bins could take various other forms as well.

As another possibility, the threshold-analysis component 206 may determine that the first candidate value for the given threshold by rounding the floor value of the Band2 bin's feature-value range for the given feature variable either down or up to a closest value along a scale comprising increments has been defined for the given feature variable. To illustrate with respect to the example groups of bins shown in FIG. 3A, this functionality could result in a first candidate value of (i) $3000 for the TRANS_AGG variable if the value of $3110 is rounded down to $3000 as the next available increment, (ii) 9 for the TRANS_OCC variable if the value of 9.5 rounded down to 9 as the next available increment, and (iii) a threshold of $4500 for the MCC_AGG variable if the value of $4270 is rounded up to $4500 as the next available increment. However, the rounded versions of the Band2 bins'floor values could take various other forms as well.

The function of determining the first candidate value for the given threshold may also take other forms as well, including but not limited to the possibility that the first candidate value for the given threshold could be determined to be (i) some other value within the Band2 bin's feature-value range that is further away from the current threshold value than the floor value or (ii) some other “above-the-line” value that is outside of the Band2 bin.

If the software-based pipeline 200 reaches the point of determining the first candidate value for the given threshold (which as noted above will be more aggressive than the current value), the threshold-analysis component 206 may then carry out one or more subsequent iterations of functionality that is similar to the foregoing functionality in order determine whether the given threshold could potentially be adjusted to one or more additional candidate values that are above-the-line relative to the first candidate value. One possible example of such functionality for determining whether the given threshold could potentially be adjusted to an additional candidate value is illustrated in FIG. 4B, where this example picks up after the determination of the first candidate value for the given threshold.

As shown in FIG. 4B, the functionality for determining whether the given threshold could potentially be adjusted to an additional candidate value may begin at block 416 with the threshold-analysis component 206 updating the set of alerts ingested by the alert-ingestion component 202 to exclude alerts that are “below-the-line” relative to the last-determined candidate value for the given threshold, which in this example would be the first candidate value. For instance, in a scenario where the first candidate value for the given threshold is determined to be the floor value of the Band2 bin's feature-values range, the threshold-analysis component 206 may update the set of alerts by excluding the alerts contained within the Band1 bin for the given feature variable, as those will be the alerts that are “below-the-line” relative to the first candidate value for the given threshold. The function of updating the set of alerts may take other forms as well.

After updating the set of alerts to exclude the alerts that are “below-the-line” relative to the first candidate value for the given threshold, the threshold-analysis component 206 may then proceed in one of two ways. In a first implementation, the alert-binning component 204 carry out another univariate binning process on the updated set of alerts in order to generate an updated group of bins with respect to the given feature variable, and the threshold-analysis component 206 may then utilize the updated set of bins as the basis for identifying and evaluating updated Band1 and Band2 bins in a manner similar to that described above. Alternatively, in a second implementation, the threshold-analysis component 206 may re-use the group of bins that was previously generated with respect to the given feature variable (but with the “below-the-line” alerts removed) as the basis for identifying and evaluating updated Band1 and Band2 bins in a manner similar to that described above.

In line with the first of these implementations, at block 418, the threshold-analysis component 206 may optionally request that the alert-binning component 204 carry out another univariate binning process on the updated set of alerts with respect to the given feature variable, and in response to that request, the alert-binning component 204 may generate the updated group of bins that are defined with respect to the given feature variable. In this respect, in some implementations, the alert-binning component 204 may generate the updated group of bins utilizing the same given set of one or more binning parameters and the same given type of binning technique that was utilized when carrying out the first iteration of the univariate binning process for generating the initial group of bins, while in other implementations, it is possible that the alert-binning component 204 may generate the updated group of bins utilizing a different set of one or more binning parameters and/or a different type of binning technique. However, in either case, the updated group of bins that are generated by the alert-binning component 204 during the second iteration of the univariate binning process will differ from the initial group of bins for at least the reason that the alerts “below-the-line” relative to the first candidate value for the given threshold are no longer included in the updated set of alerts that form the basis for the updated group of bins.

It will also be understood that this functionality of generating an updated group of bins based on an updated set of alerts is distinct from the iterative and/or recursive functionality of splitting provisional bins apart or combining provisional bins together during a single run of a binning technique for producing a single group of bins.

Regardless of whether the threshold-analysis component 206 is configured to utilize an updated group of bins produced through re-binning or the prior group of bins (with the Band1 bin removed), the threshold-analysis component 206 may also perform an initial check to verify that there are at least two bins of alerts in the updated or prior group- and if not, the threshold-analysis component 206 may terminate the functionality of FIG. 4B without determining any additional candidate value for the given threshold.

At block 420, the threshold-analysis component 206 may next identify, from among either the updated group of bins or the prior group of bins for the given feature variable, an updated first bin having a feature-value range that is closest to the first candidate value for the given threshold, which may be referred to herein as the “updated Band1” bin. As with the original Band1 bin, in practice, the bin that is identified as the updated Band1 bin will typically be the bin having a floor value that is closest to the first candidate value of the given threshold (e.g., the bin having a lower-bound value that is closest to the first candidate value if the given threshold is a maximum threshold or the bin having an upper-bound value that is closest to the first candidate value if the given threshold is a minimum threshold).

In the first implementation that is based on the updated group of bins, the updated Band1 bin that is identified will be an updated first bin of the group of bins (e.g., the updated bin identified as bin no. 1). On the other hand, in the second implementation that is based on the prior group of bins, the updated Band1 bin that is identified will be the bin from the prior group of bins that was second closest to the current value of the given threshold (i.e., the prior Band2 bin that was identified).

While function of identifying the updated Band1 bin for the given feature variable is described above as being carried out by the threshold-analysis component 206, in the first implementation, the alert-binning component 204 could identify the updated Band1 bin as part of generating the updated group of bins, in which case the alert-binning component 204 may output an indication of which updated bin is closest to the first candidate value (e.g., by using a bin identifier of “1” to demarcate the closest bin) and the threshold-analysis component 206 may in turn rely on the alert-binning component's identification of the updated Band1 bin.

At block 422, after identifying the updated Band1 bin, the threshold-analysis component 206 may next determine an updated first true-positive rate (sometimes referred to as a “yield rate”) for the updated Band1 bin identified at block 420. This function of determining the updated first true-positive rate for the updated Band1 bin may take any of various forms.

For instance, as one possibility, the threshold-analysis component 206 may determine the updated first true-positive rate for the updated Band1 bin by (i) determining a total number of alerts contained in the updated Band1 bin (e.g., based on the bin information that is output by the alert-binning component 204), (ii) determining a number of alerts contained in the updated Band1 bin that were found to be true positives (e.g., based on the validation-decision indicators for the alerts that are ingested by the alert-ingestion component 202), and (iii) dividing the number of updated Band1 alerts found to be true positives by the total number of updated Band1 alerts (and optionally multiplying the result by 100 to represent in the form of a percentage) in order to produce the updated first true-positive rate for the Band1 bin.

The function of determining the updated first true-positive rate for the updated Band1 bin may take other forms as well.

In turn, at block 424, the threshold-analysis component 206 may determine whether the updated first true-positive rate exceeds a threshold true-positive rate, which may either be the same threshold true-positive rate utilized to evaluate the initial Band1 and Band2 bins or a different threshold true-positive rate. (While this determination is described in terms of whether the updated first true-positive rate for the updated Band1 bin exceeds the threshold true-positive rate, in other implementations, the threshold-analysis component 206 may determine whether the updated first true-positive rate for the updated Band1 bin is at least equal to the threshold true-positive rate). In line with the discussion above, the threshold true-positive rate utilized at block 424 may have any of various values and may be determined in any of various manners.

If the threshold-analysis component 206 determines at block 424 that the updated first true-positive rate exceeds the threshold true-positive rate, then this indicates that the given threshold should not be adjusted to a more aggressive level than the first candidate value, and the functionality of the threshold-analysis component 206 (and the software-based pipeline 200 more generally) will terminate without determining any additional candidate values for adjusting the given threshold to a more aggressive level. In this scenario, the first candidate value may be the only candidate value for the given threshold that is utilized during the next stage of the evaluation, although in some implementations, a determination at block 424 that the updated first true-positive rate for the updated Band1 exceeds the threshold true-positive rate may be treated as an indication that even the first candidate value should not be utilized for the given threshold, in which case only the current value of the given threshold will be utilized during the next stage of the evaluation (i.e., the threshold-analysis component 206 may retroactively remove the first candidate value as a possible option for the given threshold in such an implementation).

On the other hand, if the threshold-analysis component 206 determines at block 424 that the updated first true-positive rate does not exceed the threshold true-positive rate, then this indicates that the first candidate value of the given threshold may still be too conservative and that the given threshold can potentially be adjusted to an even more aggressive level than the first candidate value, so the threshold-analysis component 206 may proceed to carry out another iteration of the additional functionality for determining whether the given threshold can be adjusted to a more aggressive level that is described above with reference to blocks 408-414.

For instance, in line with the discussion above, the threshold-analysis component 206 may thereafter (i) identify, from among either the updated group of bins or the prior group of bins, an updated Band2 bin defined by a feature-value range that is second closest to the first candidate value for the given threshold, which in the first implementation that is based on the updated group of bins will be an updated second bin of the group of bins (e.g., the updated bin identified as bin no. 1) and in the second implementation will be the bin from the prior group of bins that was third closest to the current value of the given threshold, (ii) determine an updated second true-positive rate for the updated Band2 bin, (iii) determine whether the updated second true-positive rate for the updated Band2 bin exceeds the threshold true-positive rate, and then either (iv) terminate without determining any additional candidate values for adjusting the given threshold to a more aggressive level if the updated second true-positive rate for the updated Band2 bin exceeds the threshold true-positive rate or (v) determine a second candidate value for the given threshold that is “above-the-line” relative to (i.e., more aggressive than) the first candidate of the given threshold if the updated second true-positive rate for the updated Band2 bin does not exceed the threshold true-positive rate, such as a second candidate value that is based on the floor value of the updated Band2 bin.

The threshold-analysis component 206 may also continue to carry out subsequent iterations of the functionality of FIG. 4B until the threshold-analysis component 206 either (i) terminates due to a Band1 or Band2 true-positive rate exceeding the threshold true-positive rate or (ii) reaches some other stopping condition for the functionality of the software-based pipeline 200 (e.g., identification of a threshold number of candidate values for the given threshold).

In line with the discussion above, the threshold-analysis component 206 may carry out the foregoing functionality on threshold-by-threshold basis for each threshold of the rule-based model that is to be evaluated for adjustment (e.g., thresholds for threshold-based rules that are connected by “AND” operators). In this respect, the threshold-analysis component 206 may be configured to carry out the foregoing functionality for the thresholds to be evaluated either in parallel or in series, among other possibilities.

Based on carrying out the foregoing functionality for each of the thresholds to be evaluated, the threshold-analysis component 206 may determine, for each such threshold, either (i) no candidate value for the threshold if the functionality of FIG. 4A terminates at either block 406 or 412 for the threshold due to a determination that the initial Band1 or Band2 bin's true-positive rate exceeds the threshold true-positive rate or (ii) a respective set of one or more candidate values for the threshold (where the number of candidate values in the set depends on how many iterations of the functionality of FIG. 4B successfully results in the determination of an additional candidate value for the threshold value).

To illustrate with an example, for the example rule-based model described above having the three threshold-based rules comprising the respective maximum thresholds for the TRANS_AGG, TRANS_OCC, and MCC_AGG feature variables, the threshold-analysis component 206 may determine (i) a first set of one or more candidate values (or perhaps no candidate value) for the TRANS_AGG variable, (ii) a second set of one or more candidate values (or perhaps no candidate value) for the TRANS_OCC variable, and (iii) a third set of one or more candidate values (or perhaps no candidate value) for the MCC_AGG variable. In this respect, to further illustrate with some representative examples of such candidate values, the threshold-analysis component 206 may determine (i) one candidate value for the first maximum threshold that governs the TRANS_AGG variable, which is $3000, (ii) two candidate values for the second maximum threshold that governs the TRANS_OCC variable, which are 9 and 10, and (iii) two candidate values for the third maximum threshold that governs the MCC_AGG variable, which are $4500 and $5000. However, many other examples of candidate values for these three maximum thresholds are possible as well.

After completing the foregoing functionality for the thresholds to be evaluated, the threshold-analysis component 206 may thereafter use the current and candidate values for such thresholds as a basis for determining one or more recommended options for performing an “above-the-line” adjustment of the rule-based model's thresholds. This functionality may take any of various forms.

For instance, as one possibility, the threshold-analysis component 206 may begin by generating multiple different candidate combinations of values for the thresholds using the current and candidate values for such thresholds. To illustrate with reference to the example rule-based model and the example candidate values described above, the threshold-analysis component 206 may generate up to seventeen candidate combinations of values for the three maximum thresholds governing the TRANS_AGG, TRANS_OCC, and MCC_AGG feature variables, because there are a total of eighteen possible combinations of the current and candidate values for the three maximum thresholds (2 for the TRANS_AGG variable, 3 for the TRANS_OCC variable, and 3 for the MCC_AGG variable) but one of those eighteen possible combinations is a combination of the three current values for the three maximum thresholds. However, many other examples of candidate combinations of values for these three maximum thresholds (and for various other examples of thresholds) are possible as well.

After generating the candidate combinations of values for the thresholds, the threshold-analysis component 206 may next evaluate the performance of each of the candidate combinations of values for the thresholds. This function may take any of various forms, and in at least one implementation, may involve the threshold-analysis component 206 (i) quantifying the performance of each candidate combination using one or more performance metrics, which may result in the determination of a respective set of one or more performance measures for each of the candidate combinations, and then (ii) comparing the respective sets of one or more performance measures that are determined for the candidate combinations against certain performance criteria that defines what is considered to be an acceptable level of performance for a candidate combination of threshold values. In this respect, the threshold-analysis component 206 may use any of various types of performance metrics to quantify the performance of the candidate combinations, examples of which may include (i) a first metric that indicates how many additional false negatives (i.e., missed alerts) would occur if the rule-base model's current combination of values for the thresholds had been replaced by a candidate combination of values for the thresholds, for which a lower value is better than a higher value, and/or (ii) a second metric that indicates a true-positive rate (or sometimes referred to as a “yield rate”) that would have been achieved by the rule-based model if the current combination of values for the thresholds had been replaced by a candidate combination of values for the thresholds, for which a higher value is better than a lower value, among other possible examples of performance metrics that may be utilized to quantify the performance of the candidate combinations (e.g., a metric quantifying the extent to which the candidate combination reduces the number of alerts produced by the rule-based model relative to the current threshold values). For example, the threshold-analysis component 206 may determine a first number of additional false negatives and/or a first true-positive rate for a first candidate combination, a second number of missed additional false negatives and/or a second true-positive rate for a second candidate combination, and so on for each of the other candidate combinations.

In turn, the performance criteria to which the performance measures are compared against may take any of various forms. As one possible example, such performance criteria may take the form of a respective threshold for each performance metric that must be satisfied in order to find that a candidate combination has an acceptable level of performance, such as a maximum threshold for a number of additional false negatives and a minimum threshold for a true-positive rate, among other possible examples. As another possible example, a scoring model (e.g., a rule-based model, trained machine learning model, etc.) may be utilized to combine the respective set of performance measures for each candidate combination into a respective performance score for each candidate combination, and the performance criteria may then take the form of a threshold performance score that must be satisfied in order to find that a candidate combination has an acceptable level of performance. The performance criteria to which the performance measures are compared against may take other forms as well.

The threshold-analysis component's evaluation of the performance of the candidate combinations of values for the thresholds may take various other forms as well.

Based on the evaluation of the performance of the candidate combinations of values for the thresholds, the threshold-analysis component 206 may then identify and output one or more of the candidate combinations of values for the thresholds as one or more recommended options for performing an “above-the-line” adjustment of the rule-based model's thresholds. This function may take any of various forms. As one possible example, this function may involve identifying any candidate combination that satisfies the performance criteria for acceptable performance as a recommended option for performing an “above-the-line” adjustment of the rule-based model's thresholds. As another possible example, this function may involve identifying a subset of candidate combinations that satisfy the performance criteria for acceptable performance, ranking the identified subset of candidate combinations according to some ranking criteria (e.g., based on an individual performance metric such as number of additional false negatives or true-positive rate or a performance score generated therefrom), and then selecting a given number of candidate combinations from the ranked subset starting from the top of the ranking (e.g., the top 5 candidate combinations in the ranking) as the recommended options for performing an “above-the-line” adjustment of the rule-based model's thresholds. The function of identifying the one or more recommended options for performing an “above-the-line” adjustment of the rule-based model's thresholds may take other forms as well.

To illustrate with respect to the example rule-based model and the example candidate values introduced above, FIG. 3B shows some example recommendation options that may be output by the example software-based pipeline 200 for performing an “above-the-line” adjustment of the example rule-based model's thresholds. The recommendation options are shown within a table 306, where the top row of the table 306 represents the current version of the example rule-based model comprising the current combination of values for the rule-based model's thresholds (including the three thresholds governing the TRANS_AGG, TRANS_OCC, and MCC_AGG variables) and each subsequent row of the table 306 represents a respective recommended option comprising a respective candidate combination of values for the three thresholds governing the TRANS_AGG, TRANS_OCC, and MCC_AGG variables.

Further, the table 306 is shown to include (i) a first column labeled as “Option No.” that identifies which option is represented by the row, (ii) a second column labeled as “TRANS_AGG” that includes option-specific threshold values for the TRANS_AGG feature variable, (iii) a third column labeled as “TRANS_OCC” that includes option-specific threshold values for the TRANS_OCC feature variable, (iv) a fourth column labeled as “MCC_AGG” that includes option-specific threshold values for the MCC_AGG feature variable der, (v) a fifth column labeled as “#of Alerts” that indicates a total number of alerts that would have been generated by the rule-based model during a given window of time in the past if the rule-based model's current combination of threshold values for the TRANS_AGG, TRANS_OCC, and MCC_AGG variables were replaced by the respective candidate combination of threshold values for such feature variables, (vi) a sixth column labeled as “Alert Diff %” that indicates the percent reduction in alerts that would have been achieved if the rule-based model's current combination of threshold values for the TRANS_AGG, TRANS_OCC, and MCC_AGG variables had been replaced by the respective candidate combination of threshold values for such feature variables during the given window of time in the past, (vii) a seventh column labeled as “#of False Neg” that indicates how many additional false negatives (i.e., missed alerts) would have occurred if the rule-based model's current combination of threshold values for the TRANS_AGG, TRANS_OCC, and MCC_AGG variables had been replaced by the respective candidate combination of threshold values for such feature variables during the given window of time in the past, and (viii) an eighth column labeled as “True-Pos Rate” that indicates the true-positive rate that would have been achieved by the rule-based model if the rule-based model's current combination of threshold values for the TRANS_AGG, TRANS_OCC, and MCC_AGG variables had been replaced by the respective candidate combination of threshold values for such feature variables during the given window of time in the past.

The options that are shown in the table 306 are for the candidate combinations that satisfied the performance criteria defining an acceptable level of performance, which in this example took the form of a maximum threshold of 3 for number of additional false negatives and a minimum threshold of 2.8% for true-positive rate. As such, of the seventeen possible candidate combinations of values for the three thresholds governing the TRANS_AGG, TRANS_OCC, and MCC_AGG variables, four of the candidate combinations were determined to satisfy the performance criteria defining an acceptable level of performance.

In this example, the threshold-analysis component 206 could then identify and output, as the one or more recommended options for performing an “above-the-line” adjustment of the rule-based model's thresholds, either (i) all four candidate combinations of threshold values for the TRANS_AGG, TRANS_OCC, and MCC_AGG variables shown in the table 306 or (ii) a subset of the four candidate combinations of threshold values for the TRANS_AGG, TRANS_OCC, and MCC_AGG variables shown in the table 306 (e.g., the top 1, top 2, or top 3 options based on some ranking criteria), among other possibilities.

Notably, in this example, it can be seen that each of the candidate combinations may have the capability to reduce the percentage of alerts generated by a rule-based model by at least 20% and increase the true-positive rate of the rule-based model while only producing a maximum of 2 additional false negatives- and option #7 would achieve this improved level of performance without producing any additional false negatives. Thus, the disclosed technology is capable of determining and recommending “above-the-line” options for a rule-based model's thresholds that will achieve an improved balance between avoiding false negatives and improving the true-positive rate of the alerts that are produced by the rule-based model.

The functionality that is carried out by the threshold-analysis component 206 may take other forms as well.

The example software-based pipeline 200 described above could take other forms as well. For instance, as one possibility, the example software-based pipeline 200 may include other components that are not shown or described above but may nevertheless facilitate the functionality disclosed herein. As another possibility, certain of the components shown and described above could be combined together or separated out into multiple sub-components. As yet another possibility, certain of the components shown and described above may perform additional or different functionality from what is described above, and/or may perform the described functionality in a different order from what is described above. For example, the functions of identifying the Band1 and Band2 bins and determining the true-positive rates for the Band1 and Band2 are described above as being carried by the threshold-analysis component 206 after the group of bins has been generated by the alert-binning component 204, but in an alternate implementation, the functions of identifying and determining the true-positive rates for the Band1 and Band2 bins may be performed as part of the binning process carried out by the alert-binning component 204, in which case the threshold-analysis component 206 may then receive and utilize the true-positive rates determined by the alert-binning component 204 when performing the comparisons to the threshold true-positive rate. As another example, the functions of identifying the Band1 bin, determining the true-positive rate for the Band1 bin, and comparing the true-positive rate for the Band1 bin to the threshold true-positive rate are described above as being carried out prior to performing those same function for the Band2 bin, but in an alternate implementation, these functions could be rearranged such that the identification of both the band1 and band2 bins is performed first, the determination of the true-positive rates for both the band1 and band2 bins is performed next, and the comparison of the true-positive rates for both the band1 and band2 bins to the threshold true-positive rate is performed thereafter. Other variations of the example software-based pipeline 200 are possible as well.

Further, as noted above, it is possible that the components of the example software-based pipeline 200 could be distributed across multiple different computing platforms.

Further yet, while the functionality of the example software-based pipeline 200 is at times described above in terms of determining whether and to what extent to adjust the thresholds of a rule-based model for detecting suspicious transaction activity, the example software-based pipeline 200 can similarly be utilized to determine whether and to what extent to adjust the thresholds of a rule-based model that renders predictions of some other type.

After the example software-based pipeline 200 determines the candidate combinations of values for the rule-based model's thresholds and outputs the one or more recommended options for performing an “above-the-line” adjustment of the rule-based model's thresholds in the manner described above, the one or more recommendation options may then be utilized as a basis for updating the rule-based model. For instance, as one possibility, a separate software component may be configured to receive the one or more recommendation options, automatically select an option from the one or more recommended options (e.g., based on some selection criteria related to model performance), and then automatically update the rule-based model so as to cause the current combination of values for the rule-based model's thresholds to be replaced with the threshold values of the selected option. As another possibility, the one or more recommendation options may be presented to an individual that is involved in tuning the rule-based model-which may involve the back-end computing platform 102 sending a communication to a client device 106a associated with the individual that causes the client device 106a to present the one or more recommendation options- and the individual may then in turn select an option from the one or more recommended options (e.g., based on some selection criteria related to model performance) and then input that selection into a separate software component that functions to update the rule-based model so as to cause the current combination of values for the rule-based model's thresholds to be replaced with the threshold values of the selected option. The manner in which the one or more recommendation options may be utilized to update the rule-based model may take other forms as well.

Thereafter, the updated version of the rule-based model may then be deployed and utilized to render predictions of the type for which the rule-based model was created. For example, if the rule-based model is for detecting suspicious transaction activity, then the updated version of the rule-based model may thereafter be deployed and utilized to predict whether transaction activity is suspicious and generate alerts for transaction activity that is predicted to be suspicious, which may in turn serve as a basis for triggering other downstream actions such as reporting suspicious transaction activity and/or parties involved therein to governmental agencies (e.g., via a SAR or the like), blocking future transaction activity involving certain parties (e.g., certain account holders, merchants, etc.), deactivating financial accounts of parties involved in suspicious transaction activity, and/or placing certain parties into higher risk tiers that warrant enhanced due diligence or possibly termination of business relationships, among various other possibilities. In this respect, by performing an “above-the-line” adjustment of the rule-based model's thresholds in the manner described above, the updated version of the rule-based model will be able to serve these purposes in a more efficient manner because it will produce a smaller number of alerts that are ultimately determined to be false positives.

Certain variations and/or extensions of the pipeline functionality described above may also be possible. For instance, one possible variation and/or extension of the pipeline functionality described above may involve modifying the pipeline functionality such that, instead of generating bins and evaluating candidate values on a threshold-by-threshold basis as described above, the pipeline functionality involves utilizing a multivariate binning process to generate a group of bins with respect to the multiple thresholds that are to be evaluated and then carrying out the threshold-analysis functionality with respect to that group of bins. In this respect, each bin in the group will be defined by a respective set of feature-value ranges for the feature variables governed by the thresholds to be evaluated, and each such bin's respective set of feature-value ranges will differ from the other bins in the group with respect to at least one feature variable (and perhaps multiple feature variables). In turn, the threshold-analysis functionality for such a group of bins may involve identifying the Band1 and Band2 bins that are closest and second closest to the current values of the thresholds by representing the bins and the combination of current values as points within a multidimensional space and then evaluating the respective distances between the points representing the bins and the point representing the combination of current values. In this respect, the functionality of FIGS. 4A and 4B will result in a determination of one or more particular combinations of candidate values for the multiple thresholds to be evaluated (e.g., combinations of values that are defined based on the floor values of the feature-value ranges that define the Band2 bin identified during the first iteration of FIG. 4A and the updated Band2 bin identified each subsequent iteration of FIG. 4B) rather than a determination of one or more candidate values for one particular threshold to be evaluated, in which case the threshold-analysis component 206 could either (i) output the one or more particular combinations of candidate values for the multiple thresholds as the one or more recommended options for performing an “above-the-line” adjustment of the rule-based model's thresholds or (ii) using the one or more particular combinations of candidate values for the multiple thresholds as a basis for generating a wider range of possible options for the threshold values and then evaluate the performance of such options in order to identify which of the options to identify as the one or more recommended options for performing an “above-the-line” adjustment of the rule-based model's thresholds.

Another possible variation and/or extension of the pipeline functionality described above may involve checking for additional stopping conditions during the functionality of FIG. 4A and/or FIG. 4B. For instance, in addition to checking whether the Band1 and Band2 true-positive rates exceed the threshold true-positive rate and checking whether the group of bins being utilized for the analysis includes at least two bins-which are two types of stopping conditions discussed above-the threshold-analysis component 206 may be configured to verify that each determined candidate value for the given threshold will improve the true-positive rate of the rule-based model (or at least cause it to remain the same) before initiating another iteration of the FIG. 4B functionality for the given threshold in order to evaluate whether to determine an additional candidate value for the given threshold, and if not, the threshold-analysis component 206 may terminate the functionality for the given threshold without determining any additional candidate value. In this respect, after each candidate value is determined, the threshold-analysis component 206 may (i) determine a true-positive rate that would have been achieved the rule-based model during a past window of time if the current value of the given threshold was replaced by the determined candidate value, (ii) compare the determined true-positive rate to the true-positive rate that was actually achieved by the rule-based model during the past window of time, and then either (iii) verify that the determined candidate value improves the true-positive rate (or at least keeps it the same) and proceed to the next iteration or (iv) determine that the determined candidate value reduces the true-positive rate and terminate the functionality for the given threshold without determining any additional candidate value.

Other variations and/or extensions of the pipeline functionality described above are possible as well.

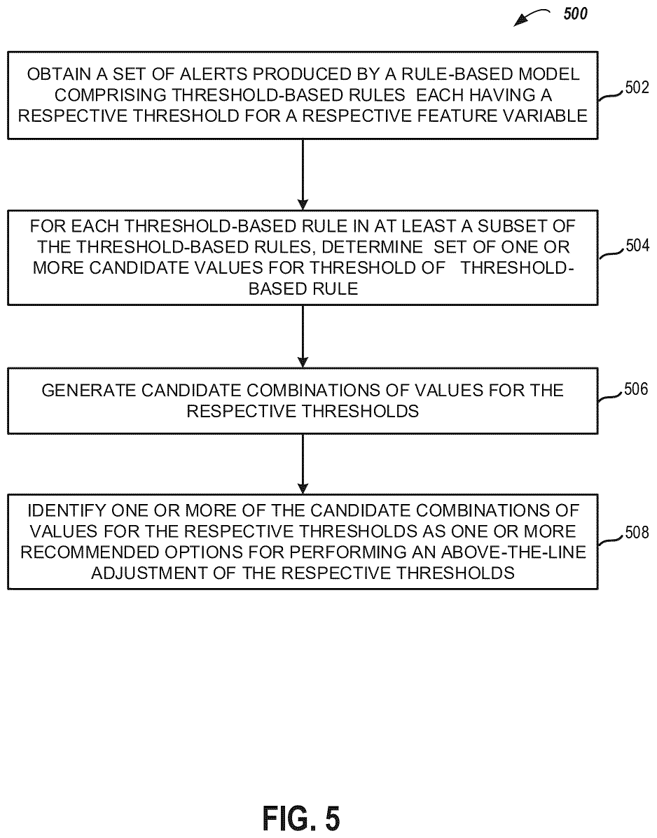

One possible example of functionality 500 that may be carried out in accordance with the disclosed software technology will now be described with reference to the flow chart of FIG. 5. In practice, the functionality 500 of FIG. 5 may be encoded in the form of program instructions that are executable by one or more processors of a computing platform, and for purposes of illustration, the functionality 500 of FIG. 5 is described as being carried out by the back-end computing platform 102 of FIG. 1, but it should be understood that the functionality 500 of FIG. 5 may be carried out by any one or more computing platforms that are capable of being installed with software for performing the functions described below. Further, it should be understood that the functionality 500 of FIG. 5 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

As shown in FIG. 5, the functionality 500 may begin at block 502 with the back-end computing platform 102 obtaining a set of alerts produced by a rule-based model that is configured to render predictions of a given type (e.g., whether transaction activity is suspicious) based on feature values for an input set of feature variables, where that rule-based model comprises threshold-based rules that each include a respective threshold for a respective feature variable from the input set of feature variables. The rule-based model and its threshold-based rules may take any of various forms, including but not limited to any of the various forms of rule-based models and threshold-based rules discussed above.

At block 504, the back-end computing platform 102 may next determine, for each respective threshold-based rule in at least a subset of the threshold-based rules, a respective set of one or more candidate values for the respective threshold of the respective threshold-based rule. This function may be carried out in line with the functionality described above with reference to FIGS. 2, 3A-3B, and 4A-4B.

For instance, in line with the discussion above, this function may involve, for each respective threshold-based rule in at least a subset of the threshold-based rules: (a) arranging the set of alerts into a respective group of bins that each contains a different subset of the set of alerts and are each defined by a different feature-value range for the respective feature variable of the respective threshold-based rule, (b) identifying, from among the respective group of bins, a first bin defined by a first feature-value range for the respective feature variable of the respective threshold-based rule that is closest to a current value for the respective threshold of the respective threshold-based rule, (c) comparing a first true-positive rate of a first subset of alerts contained within the first bin to a threshold true-positive rate and thereby make a determination that the first true-positive rate is less than the threshold true-positive rate, (d) identifying, from among the respective group of bins, a second bin defined by a second feature-value range for the respective feature variable of the respective threshold-based rule that is second closest to the current value for the respective threshold of the respective threshold-based rule, (e) comparing a second true-positive rate of a second subset of alerts contained within the second bin to a threshold true-positive rate and thereby make a determination that the second true-positive rate is less than the threshold true-positive rate, (f) based on the determinations that the first and second true-positive rates are both less than the threshold true-positive rate, determining a first candidate value to include in the respective set of one or more candidate values for the respective threshold of the respective threshold-based rule, wherein the first candidate value is more aggressive than the current value for the respective threshold, and (g) carrying out additional functionality for determining whether to include one or more additional candidate values in the respective set of one or more candidate values for the respective threshold of the respective threshold-based rule.

In line with the discussion above, the function of determining a respective set of one or more candidate values for a respective threshold of a respective threshold-based rule could also take other forms as well.

At block 506, based on the respective sets of one or more candidate values that are determined at block 504 for the respective thresholds of the respective threshold-based rules in at least the subset of the threshold-based rules, the back-end computing platform 102 may next generate candidate combinations of values for the respective thresholds. In line with the discussion above, this function of generating the candidate combinations of values for the respective thresholds may involve generating multiple different combinations of values for the respective thresholds that each includes either (i) determined candidate values for all of the respective thresholds or (ii) a mixture of candidate and current values for the respective thresholds (e.g., one or more candidate values and one or more current values).

Lastly, at block 508, the back-end computing platform 102 may identify one or more of the candidate combinations of values for the respective thresholds as one or more recommended options for performing an above-the-line adjustment of the respective thresholds. In line with the discussion above, this function may involve evaluating the performance of each of the candidate combinations of values for the respective thresholds (e.g., based on a performance metric such as a number of false negatives, a true-positive rate, etc.) and then identifying the one or more recommended candidate combinations based on this evaluation, among other possible ways that the one or more recommended candidate combinations may be identified.

As noted, the functionality 500 may take various other forms as well. For instance, it is possible that the functionality 500 may include additional and/or different functions than those shown in FIG. 5, including but not limited to any additional and/or different functions that are described above with reference to FIGS. 2, 3A-3B, and 4A-4B.

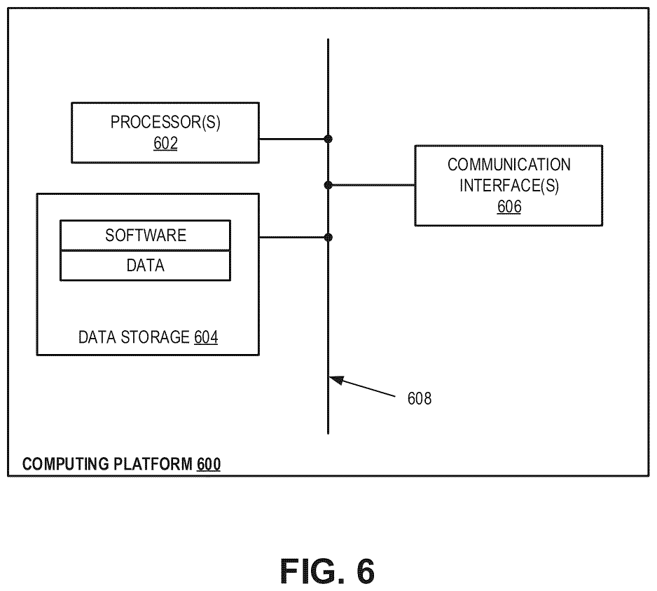

Turning now to FIG. 6, a simplified block diagram is provided to illustrate some structural components that may be included in an example computing platform 600 that may be configured to perform some or all of the platform functions disclosed herein. At a high level, the example computing platform 600 may generally comprise any one or more computer systems (e.g., one or more servers) that collectively include one or more processors 602, data storage 604, and one or more communication interfaces 606, all of which may be communicatively linked by a communication link 608 that may take the form of a system bus, a communication network such as a public, private, or hybrid cloud, or some other connection mechanism. Each of these components may take various forms.

For instance, the one or more processors 602 may comprise one or more processor components, such as one or more central processing units (CPUs), graphics processing unit (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 602 could comprise processing components that are distributed across a plurality of physical computing devices connected via a network, such as a computing cluster of a public, private, or hybrid cloud.

In turn, the data storage 604 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 604 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 6, the data storage 604 may be capable of storing both (i) program instructions that are executable by the one or more processors 602 such that the example computing platform 600 is configured to perform any of the various functions disclosed herein (including but not limited to any of the platform functions discussed above), and (ii) data that may be received, derived, or otherwise stored by the example computing platform 600.

The one or more communication interfaces 606 may comprise one or more interfaces that facilitate communication between the example computing platform 600 and other systems or devices, where each such interface may be wired and/or wireless and may communicate according to any of various communication protocols. As examples, the one or more communication interfaces 606 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 600 may additionally have an I/O interface that includes or provides connectivity to I/O components that facilitate user interaction with the example computing platform 600, such as a keyboard, a mouse, a trackpad, a display screen, a touch-sensitive interface, a stylus, a virtual-reality headset, and/or one or more speaker components, among other possibilities.

It should be understood that the example computing platform 600 is one example of a computing platform that may be used with the embodiments described herein. Numerous other arrangements are possible and contemplated herein. For instance, in other embodiments, the example computing platform 600 may include additional components not pictured and/or more or less of the pictured components.

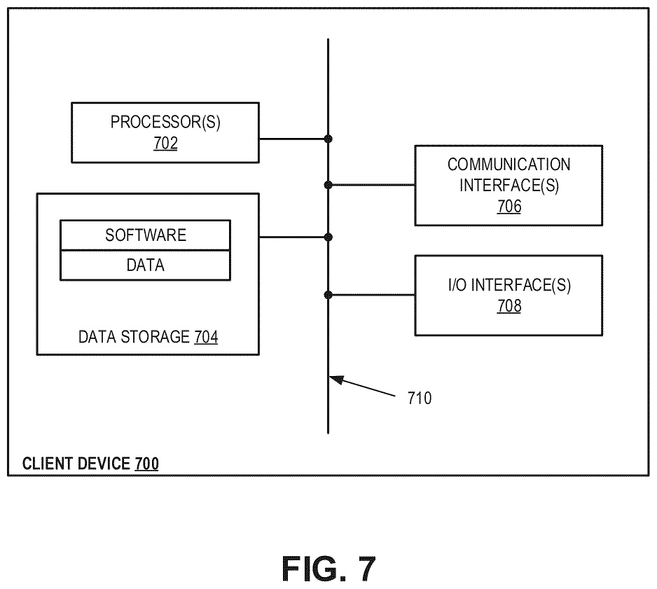

Turning next to FIG. 7, a simplified block diagram is provided to illustrate some structural components that may be included in an example client device 700 that may be configured to perform some or all of the client-device functions disclosed herein. At a high level, the example client device 700 may include one or more processors 702, data storage 704, one or more communication interfaces 706, and an I/O interface 708, all of which may be communicatively linked by a communication link 710 that may take the form of a system bus and/or some other connection mechanism. Each of these components may take various forms.

For instance, the one or more processors 702 of the example client device 700 may comprise one or more processor components, such as one or more CPUs, GPUs, ASICs, DSPs, and/or programmable logic devices such as FPGAs, among other possible types of processing components.

In turn, the data storage 704 of the example client device 700 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 7, the data storage 704 may be capable of storing both (i) program instructions that are executable by the one or more processors 702 of the example client device 700 such that the example client device 700 is configured to perform any of the various functions disclosed herein (including but not limited to any of the client-device functions discussed above), and (ii) data that may be received, derived, or otherwise stored by the example client device 700.

The one or more communication interfaces 706 may comprise one or more interfaces that facilitate communication between the example client device 700 and other systems or devices, where each such interface may be wired and/or wireless and may communicate according to any of various communication protocols. As examples, the one or more communication interfaces 706 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 708 may generally take the form of (i) one or more input interfaces that are configured to receive and/or capture information at the example client device 700 and (ii) one or more output interfaces that are configured to output information from the example client device 700 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 708 may include or provide connectivity to output components such as a display screen and/or an audio speaker, among other possibilities.

It should be understood that the example client device 700 is one example of a client device that may be used with the example embodiments described herein. Numerous other arrangements are possible and contemplated herein. For instance, in other embodiments, the example client device 700 may include additional components not pictured and/or more or fewer of the pictured components.

### Conclusion

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

We claim:

1. A computing platform comprising:
at least one communication interface;
at least one processor;
at least one non-transitory computer-readable medium; and
program instructions stored on the at least one non-transitory computer-readable medium that, when executed by the at least one processor, cause the computing platform to:
obtain a set of alerts produced by a rule-based model that is configured to render predictions of a given type based on feature values for an input set of feature variables, wherein the rule-based model comprises threshold-based rules that each include a respective threshold for a respective feature variable from the input set of feature variables;
for each respective threshold-based rule in at least a subset of the threshold-based rules, determine a respective set of one or more candidate values for the respective threshold of the respective threshold-based rule by:
arranging the set of alerts into a respective group of bins that each contains a different subset of the set of alerts and are each defined by a different feature-value range for the respective feature variable of the respective threshold-based rule;
identifying, from among the respective group of bins, a first bin defined by a first feature-value range for the respective feature variable of the respective threshold-based rule that is closest to a current value for the respective threshold of the respective threshold-based rule;
comparing a first true-positive rate of a first subset of alerts contained within the first bin to a threshold true-positive rate and thereby make a determination that the first true-positive rate is less than the threshold true-positive rate;
identifying, from among the respective group of bins, a second bin defined by a second feature-value range for the respective feature variable of the respective threshold-based rule that is second closest to the current value for the respective threshold of the respective threshold-based rule;
comparing a second true-positive rate of a second subset of alerts contained within the second bin to a threshold true-positive rate and thereby make a determination that the second true-positive rate is less than the threshold true-positive rate;
based on the determinations that the first and second true-positive rates are both less than the threshold true-positive rate, determining a first candidate value to include in the respective set of one or more candidate values for the respective threshold of the respective threshold-based rule, wherein the first candidate value is more aggressive than the current value for the respective threshold; and
carrying out additional functionality for determining whether to include one or more additional candidate values in the respective set of one or more candidate values for the respective threshold of the respective threshold-based rule;
based on the respective sets of one or more candidate values that are determined for the respective thresholds of the respective threshold-based rules in at least the subset of the threshold-based rules, generate candidate combinations of values for the respective thresholds; and
identify one or more of the candidate combinations of values for the respective thresholds as one or more recommended options for performing an above-the-line adjustment of the respective thresholds.

2. The computing platform of claim 1, wherein the rule-based model is thereafter updated to include a given one of the candidate combination of values for the respective thresholds in place of a current combination of values for the respective thresholds.

3. The computing platform of claim 1, wherein the predictions of the given type that are rendered by the rule-based model comprise predictions of whether transaction activity is suspicious.

4. The computing platform of claim 1, wherein, for each respective threshold-based rule in at least the subset of the threshold-based rules, the first candidate value for the respective threshold of the respective threshold-based rule is determined based on the second feature-value range that defines the second bin.

5. The computing platform of claim 1, wherein, for each respective threshold-based rule in at least the subset of the threshold-based rules, carrying out the additional functionality for determining whether to include the one or more additional candidate values in the respective set of one or more candidate values for the respective threshold of the respective threshold-based rule comprises:
identifying, from among a respective updated group of bins, an updated first bin defined by an updated first feature-value range for the respective feature variable of the respective threshold-based rule that is closest to the first candidate value for the respective threshold of the respective threshold-based rule;
comparing an updated first true-positive rate of an updated first subset of alerts contained within the updated first bin to the threshold true-positive rate and thereby make a determination that the updated first true-positive rate is less than the threshold true-positive rate;
identifying, from among the respective updated group of bins, an updated second bin defined by an updated second feature-value range for the respective feature variable of the respective threshold-based rule that is second closest to the first candidate value for the respective threshold of the respective threshold-based rule;
comparing an updated second true-positive rate of an updated second subset of alerts contained within the updated second bin to a threshold true-positive rate and thereby make a determination that the updated second true-positive rate is less than the threshold true-positive rate;
based on the determinations that the updated first and updated second true-positive rates are both less than the threshold true-positive rate, determining a second candidate value to include in the respective set of one or more candidate values for the respective threshold of the respective threshold-based rule, wherein the second candidate value is more aggressive than the first candidate value for the respective threshold.

6. The computing platform of claim 5, wherein, for each respective threshold-based rule in at least the subset of the threshold-based rules, the respective updated group of bins comprises an updated version of the respective group of bins that excludes the first bin and includes all other bins of the respective group of bins.

7. The computing platform of claim 5, wherein, for each respective threshold-based rule in at least the subset of the threshold-based rules, the respective updated group of bins comprises a respective new group of bins that is generated by (i) updating the set of alerts to remove the first subset of alerts contained within the first bin and (ii) arranging the update set of alerts into the respective new group of bins that each contains a different subset of the updated set of alerts and are each defined by a different feature-value range for the respective feature variable of the respective threshold-based rule.

8. The computing platform of claim 1, wherein the program instructions stored on the at least one non-transitory computer-readable medium that, when executed by the at least one processor, cause the computing platform to identify the one or more of the candidate combinations of values for the respective thresholds as the one or more recommended options for performing an above-the-line adjustment of the respective thresholds comprise program instructions stored on the at least one non-transitory computer-readable medium that, when executed by the at least one processor, cause the computing platform to:
evaluate a respective performance level of each of the candidate combinations of values for the respective thresholds; and
based on evaluating the respective performance level of each of the candidate combinations of values for the respective thresholds, identify the one or more of the candidate combinations of values for the respective thresholds as the one or more recommended options for performing an above-the-line adjustment of the respective thresholds.

9. The computing platform of claim 8, wherein the program instructions stored on the at least one non-transitory computer-readable medium that, when executed by the at least one processor, cause the computing platform to evaluate the respective performance level of each of the candidate combinations of values for the respective thresholds comprise program instructions stored on the at least one non-transitory computer-readable medium that, when executed by the at least one processor, cause the computing platform to:
determine, for each of the candidate combinations of values for the respective thresholds, one or both of (i) a respective indication of how many additional false negatives would have occurred during a past window of time if a current combination of values for the respective thresholds had been replaced by the candidate combination of value for the respective thresholds or (ii) a respective indication of a true-positive rate that would have been achieved during the past window of time if the current combination of values for the respective thresholds had been replaced by the candidate combination of value for the respective thresholds.

10. A non-transitory computer-readable medium, wherein the non-transitory computer-readable medium is provisioned with program instructions that, when executed by at least one processor, cause a computing platform to:
obtain a set of alerts produced by a rule-based model that is configured to render predictions of a given type based on feature values for an input set of feature variables, wherein the rule-based model comprises threshold-based rules that each include a respective threshold for a respective feature variable from the input set of feature variables;
for each respective threshold-based rule in at least a subset of the threshold-based rules, determine a respective set of one or more candidate values for the respective threshold of the respective threshold-based rule by:
arranging the set of alerts into a respective group of bins that each contains a different subset of the set of alerts and are each defined by a different feature-value range for the respective feature variable of the respective threshold-based rule;
identifying, from among the respective group of bins, a first bin defined by a first feature-value range for the respective feature variable of the respective threshold-based rule that is closest to a current value for the respective threshold of the respective threshold-based rule;
comparing a first true-positive rate of a first subset of alerts contained within the first bin to a threshold true-positive rate and thereby make a determination that the first true-positive rate is less than the threshold true-positive rate;
identifying, from among the respective group of bins, a second bin defined by a second feature-value range for the respective feature variable of the respective threshold-based rule that is second closest to the current value for the respective threshold of the respective threshold-based rule;
comparing a second true-positive rate of a second subset of alerts contained within the second bin to a threshold true-positive rate and thereby make a determination that the second true-positive rate is less than the threshold true-positive rate;
based on the determinations that the first and second true-positive rates are both less than the threshold true-positive rate, determining a first candidate value to include in the respective set of one or more candidate values for the respective threshold of the respective threshold-based rule, wherein the first candidate value is more aggressive than the current value for the respective threshold; and
carrying out additional functionality for determining whether to include one or more additional candidate values in the respective set of one or more candidate values for the respective threshold of the respective threshold-based rule;
based on the respective sets of one or more candidate values that are determined for the respective thresholds of the respective threshold-based rules in at least the subset of the threshold-based rules, generate candidate combinations of values for the respective thresholds; and
identify one or more of the candidate combinations of values for the respective thresholds as one or more recommended options for performing an above-the-line adjustment of the respective thresholds.

11. The non-transitory computer-readable medium of claim 10, wherein the rule-based model is thereafter updated to include a given one of the candidate combination of values for the respective thresholds in place of a current combination of values for the respective thresholds.

12. The non-transitory computer-readable medium of claim 10, wherein, for each respective threshold-based rule in at least the subset of the threshold-based rules, carrying out the additional functionality for determining whether to include the one or more additional candidate values in the respective set of one or more candidate values for the respective threshold of the respective threshold-based rule comprises:
identifying, from among a respective updated group of bins, an updated first bin defined by an updated first feature-value range for the respective feature variable of the respective threshold-based rule that is closest to the first candidate value for the respective threshold of the respective threshold-based rule;
comparing an updated first true-positive rate of an updated first subset of alerts contained within the updated first bin to the threshold true-positive rate and thereby make a determination that the updated first true-positive rate is less than the threshold true-positive rate;
identifying, from among the respective updated group of bins, an updated second bin defined by an updated second feature-value range for the respective feature variable of the respective threshold-based rule that is second closest to the first candidate value for the respective threshold of the respective threshold-based rule;
comparing an updated second true-positive rate of an updated second subset of alerts contained within the updated second bin to a threshold true-positive rate and thereby make a determination that the updated second true-positive rate is less than the threshold true-positive rate;
based on the determinations that the updated first and updated second true-positive rates are both less than the threshold true-positive rate, determining a second candidate value to include in the respective set of one or more candidate values for the respective threshold of the respective threshold-based rule, wherein the second candidate value is more aggressive than the first candidate value for the respective threshold.

13. The non-transitory computer-readable medium of claim 10, wherein the program instructions that, when executed by the at least one processor, cause the computing platform to identify the one or more of the candidate combinations of values for the respective thresholds as the one or more recommended options for performing an above-the-line adjustment of the respective thresholds comprise program instructions that, when executed by the at least one processor, cause the computing platform to:
evaluate a respective performance level of each of the candidate combinations of values for the respective thresholds; and
based on evaluating the respective performance level of each of the candidate combinations of values for the respective thresholds, identify the one or more of the candidate combinations of values for the respective thresholds as the one or more recommended options for performing an above-the-line adjustment of the respective thresholds.

14. A method carried out by a computing platform, the method comprising:
obtaining a set of alerts produced by a rule-based model that is configured to render predictions of a given type based on feature values for an input set of feature variables, wherein the rule-based model comprises threshold-based rules that each include a respective threshold for a respective feature variable from the input set of feature variables;
for each respective threshold-based rule in at least a subset of the threshold-based rules, determining a respective set of one or more candidate values for the respective threshold of the respective threshold-based rule by:
arranging the set of alerts into a respective group of bins that each contains a different subset of the set of alerts and are each defined by a different feature-value range for the respective feature variable of the respective threshold-based rule;
identifying, from among the respective group of bins, a first bin defined by a first feature-value range for the respective feature variable of the respective threshold-based rule that is closest to a current value for the respective threshold of the respective threshold-based rule;
comparing a first true-positive rate of a first subset of alerts contained within the first bin to a threshold true-positive rate and thereby make a determination that the first true-positive rate is less than the threshold true-positive rate;
identifying, from among the respective group of bins, a second bin defined by a second feature-value range for the respective feature variable of the respective threshold-based rule that is second closest to the current value for the respective threshold of the respective threshold-based rule;
comparing a second true-positive rate of a second subset of alerts contained within the second bin to a threshold true-positive rate and thereby make a determination that the second true-positive rate is less than the threshold true-positive rate;
based on the determinations that the first and second true-positive rates are both less than the threshold true-positive rate, determining a first candidate value to include in the respective set of one or more candidate values for the respective threshold of the respective threshold-based rule, wherein the first candidate value is more aggressive than the current value for the respective threshold; and
carrying out additional functionality for determining whether to include one or more additional candidate values in the respective set of one or more candidate values for the respective threshold of the respective threshold-based rule;
based on the respective sets of one or more candidate values that are determined for the respective thresholds of the respective threshold-based rules in at least the subset of the threshold-based rules, generating candidate combinations of values for the respective thresholds; and
identifying one or more of the candidate combinations of values for the respective thresholds as one or more recommended options for performing an above-the-line adjustment of the respective thresholds.

15. The method of claim 14, wherein the rule-based model is thereafter updated to include a given one of the candidate combination of values for the respective thresholds in place of a current combination of values for the respective thresholds.

16. The method of claim 14, wherein the predictions of the given type that are rendered by the rule-based model comprise predictions of whether transaction activity is suspicious.

17. The method of claim 14, wherein, for each respective threshold-based rule in at least the subset of the threshold-based rules, the first candidate value for the respective threshold of the respective threshold-based rule is determined based on the second feature-value range that defines the second bin.

18. The method of claim 14, wherein, for each respective threshold-based rule in at least the subset of the threshold-based rules, carrying out the additional functionality for determining whether to include the one or more additional candidate values in the respective set of one or more candidate values for the respective threshold of the respective threshold-based rule comprises:
identifying, from among a respective updated group of bins, an updated first bin defined by an updated first feature-value range for the respective feature variable of the respective threshold-based rule that is closest to the first candidate value for the respective threshold of the respective threshold-based rule;
comparing an updated first true-positive rate of an updated first subset of alerts contained within the updated first bin to the threshold true-positive rate and thereby make a determination that the updated first true-positive rate is less than the threshold true-positive rate;
identifying, from among the respective updated group of bins, an updated second bin defined by an updated second feature-value range for the respective feature variable of the respective threshold-based rule that is second closest to the first candidate value for the respective threshold of the respective threshold-based rule;
comparing an updated second true-positive rate of an updated second subset of alerts contained within the updated second bin to a threshold true-positive rate and thereby make a determination that the updated second true-positive rate is less than the threshold true-positive rate;
based on the determinations that the updated first and updated second true-positive rates are both less than the threshold true-positive rate, determining a second candidate value to include in the respective set of one or more candidate values for the respective threshold of the respective threshold-based rule, wherein the second candidate value is more aggressive than the first candidate value for the respective threshold.

19. The method of claim 14, wherein identifying the one or more of the candidate combinations of values for the respective thresholds as the one or more recommended options for performing an above-the-line adjustment of the respective thresholds comprises:
evaluating a respective performance level of each of the candidate combinations of values for the respective thresholds; and
based on evaluating the respective performance level of each of the candidate combinations of values for the respective thresholds, identifying the one or more of the candidate combinations of values for the respective thresholds as the one or more recommended options for performing an above-the-line adjustment of the respective thresholds.

20. The method of claim 19, wherein evaluating the respective performance level of each of the candidate combinations of values for the respective thresholds comprises:
determining, for each of the candidate combinations of values for the respective thresholds, one or both of (i) a respective indication of how many additional false negatives would have occurred during a past window of time if a current combination of values for the respective thresholds had been replaced by the candidate combination of value for the respective thresholds or (ii) a respective indication of a true-positive rate that would have been achieved during the past window of time if the current combination of values for the respective thresholds had been replaced by the candidate combination of value for the respective thresholds.
